(19) United States
(12) Patent Application Publication
(10) Pub. No.: US 2025/0377768 A1
(43) Pub. Date: Dec. 11, 2025

(54) TECHNIQUES FOR MANAGING HOME HUBS

(71) Applicant: Apple Inc., Cupertino, CA (US)

(72) Inventors: Mischa K. MCLACHLAN, San Francisco, CA (US); Vincenzo O. GIULIANI, Thousand Oaks, CA (US)

(21) Appl. No.: 19/223,636

(22) Filed: May 30, 2025

Related U.S. Application Data
(60) Provisional application No. 63/657,893, filed on Jun. 9, 2024.

(51) Int. Cl. G06F 3/0484

(52) U.S. Cl. CPC G06F 3/0484

(57) ABSTRACT

The present disclosure generally relates to managing home hubs. Some techniques are for displaying a device as an active hub device in accordance with some embodiments. Other techniques are for displaying a notification of a state of hub device in accordance with some embodiments.

### CROSS-REFERENCE TO RELATED APPLICATIONS

The present application claims priority to U.S. Provisional Patent Application Ser. No. 63/657,893, entitled “TECHNIQUES FOR MANAGING HOME HUBS” filed Jun. 9, 2024, which is hereby incorporated by reference in its entirety for all purposes.

### FIELD

The present disclosure relates generally to computer user interfaces, and more specifically to techniques for displaying content.

### BACKGROUND

Managing a smart home system with multiple devices that can serve as a home hub has become increasingly challenging. For example, the selection of an appropriate home hub can affect the performance of the smart home system. Consequently, there is a need to enhance techniques for managing home hubs.

### SUMMARY

Some techniques for managing home hubs, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for managing home hubs. Such processes and interfaces optionally complement or replace other processes for managing home hubs. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is in communication with a display generation component is described. In some embodiments, the method comprises: while displaying, via the display generation component, an indication of a first device as an active hub device for one or more accessory devices, detecting a state of the first device; and in response to detecting the state of the first device and in accordance with a determination that a first set of one or more criteria is satisfied, wherein the first set of one or more criteria includes a first criterion that is satisfied when the state of the first device is a first state: ceasing display of, via the display generation component, the indication of the first device as the active hub device for the one or more accessory devices; and displaying, via the display generation component, an indication of a second device as the active hub device for the one or more accessory devices, wherein the indication of the first device as the active hub device for the one or more accessory devices is different from the indication of the second device as the active hub device for the one or more accessory devices, and wherein the second device is different from the first device.

In some embodiments, a non-transitory computer-readable storage medium storing one or more programs configured to be executed by one or more processors of a computer system that is in communication with a display generation component is described. In some embodiments, the one or more programs includes instructions for: while displaying, via the display generation component, an indication of a first device as an active hub device for one or more accessory devices, detecting a state of the first device; and in response to detecting the state of the first device and in accordance with a determination that a first set of one or more criteria is satisfied, wherein the first set of one or more criteria includes a first criterion that is satisfied when the state of the first device is a first state: ceasing display of, via the display generation component, the indication of the first device as the active hub device for the one or more accessory devices; and displaying, via the display generation component, an indication of a second device as the active hub device for the one or more accessory devices, wherein the indication of the first device as the active hub device for the one or more accessory devices is different from the indication of the second device as the active hub device for the one or more accessory devices, and wherein the second device is different from the first device.

In some embodiments, a transitory computer-readable storage medium storing one or more programs configured to be executed by one or more processors of a computer system that is in communication with a display generation component is described. In some embodiments, the one or more programs includes instructions for: while displaying, via the display generation component, an indication of a first device as an active hub device for one or more accessory devices, detecting a state of the first device; and in response to detecting the state of the first device and in accordance with a determination that a first set of one or more criteria is satisfied, wherein the first set of one or more criteria includes a first criterion that is satisfied when the state of the first device is a first state: ceasing display of, via the display generation component, the indication of the first device as the active hub device for the one or more accessory devices; and displaying, via the display generation component, an indication of a second device as the active hub device for the one or more accessory devices, wherein the indication of the first device as the active hub device for the one or more accessory devices is different from the indication of the second device as the active hub device for the one or more accessory devices, and wherein the second device is different from the first device.

In some embodiments, a computer system configured to communicate with a display generation component is described. In some embodiments, the computer system comprises one or more processors and memory storing one or more programs configured to be executed by the one or more processors. In some embodiments, the one or more programs includes instructions for: while displaying, via the display generation component, an indication of a first device as an active hub device for one or more accessory devices, detecting a state of the first device; and in response to detecting the state of the first device and in accordance with a determination that a first set of one or more criteria is satisfied, wherein the first set of one or more criteria includes a first criterion that is satisfied when the state of the first device is a first state: ceasing display of, via the display generation component, the indication of the first device as the active hub device for the one or more accessory devices; and displaying, via the display generation component, an indication of a second device as the active hub device for the one or more accessory devices, wherein the indication of the first device as the active hub device for the one or more accessory devices is different from the indication of the second device as the active hub device for the one or more accessory devices, and wherein the second device is different from the first device.

In some embodiments, a computer system configured to communicate with a display generation component is described. In some embodiments, the computer system comprises means for performing each of the following steps: while displaying, via the display generation component, an indication of a first device as an active hub device for one or more accessory devices, detecting a state of the first device; and in response to detecting the state of the first device and in accordance with a determination that a first set of one or more criteria is satisfied, wherein the first set of one or more criteria includes a first criterion that is satisfied when the state of the first device is a first state: ceasing display of, via the display generation component, the indication of the first device as the active hub device for the one or more accessory devices; and displaying, via the display generation component, an indication of a second device as the active hub device for the one or more accessory devices, wherein the indication of the first device as the active hub device for the one or more accessory devices is different from the indication of the second device as the active hub device for the one or more accessory devices, and wherein the second device is different from the first device.

In some embodiments, a computer program product is described. In some embodiments, the computer program product comprises one or more programs configured to be executed by one or more processors of a computer system that is in communication with a display generation component. In some embodiments, the one or more programs include instructions for: while displaying, via the display generation component, an indication of a first device as an active hub device for one or more accessory devices, detecting a state of the first device; and in response to detecting the state of the first device and in accordance with a determination that a first set of one or more criteria is satisfied, wherein the first set of one or more criteria includes a first criterion that is satisfied when the state of the first device is a first state: ceasing display of, via the display generation component, the indication of the first device as the active hub device for the one or more accessory devices; and displaying, via the display generation component, an indication of a second device as the active hub device for the one or more accessory devices, wherein the indication of the first device as the active hub device for the one or more accessory devices is different from the indication of the second device as the active hub device for the one or more accessory devices, and wherein the second device is different from the first device.

In some embodiments, a method that is performed at a computer system that is in communication with a display generation component and an input device is described. In some embodiments, the method comprises: detecting a state corresponding to a hub device for one or more accessory devices; and in response to detecting the state corresponding to the hub device for the one or more accessory devices: in accordance with a determination that a first set of one or more criteria is satisfied, wherein the first set of one or more criteria includes a criterion that is satisfied when the hub device for the one or more accessory devices was manually selected for a network and that the state corresponding to the hub device for the one or more accessory devices corresponds to a first state, displaying, via the display generation component, a first notification; and in accordance with a determination that a second set of one or more criteria, different from the first set of one or more criteria, is satisfied, wherein the second set of one or more criteria includes a criterion that is satisfied when the state corresponding to the hub device for the one or more accessory devices corresponds to the first state, forgoing display of, via the display generation component, the first notification.

In some embodiments, a non-transitory computer-readable storage medium storing one or more programs configured to be executed by one or more processors of a computer system that is in communication with a display generation component and an input device is described. In some embodiments, the one or more programs includes instructions for: detecting a state corresponding to a hub device for one or more accessory devices; and in response to detecting the state corresponding to the hub device for the one or more accessory devices: in accordance with a determination that a first set of one or more criteria is satisfied, wherein the first set of one or more criteria includes a criterion that is satisfied when the hub device for the one or more accessory devices was manually selected for a network and that the state corresponding to the hub device for the one or more accessory devices corresponds to a first state, displaying, via the display generation component, a first notification; and in accordance with a determination that a second set of one or more criteria, different from the first set of one or more criteria, is satisfied, wherein the second set of one or more criteria includes a criterion that is satisfied when the state corresponding to the hub device for the one or more accessory devices corresponds to the first state, forgoing display of, via the display generation component, the first notification.

In some embodiments, a transitory computer-readable storage medium storing one or more programs configured to be executed by one or more processors of a computer system that is in communication with a display generation component and an input device is described. In some embodiments, the one or more programs includes instructions for: detecting a state corresponding to a hub device for one or more accessory devices; and in response to detecting the state corresponding to the hub device for the one or more accessory devices: in accordance with a determination that a first set of one or more criteria is satisfied, wherein the first set of one or more criteria includes a criterion that is satisfied when the hub device for the one or more accessory devices was manually selected for a network and that the state corresponding to the hub device for the one or more accessory devices corresponds to a first state, displaying, via the display generation component, a first notification; and in accordance with a determination that a second set of one or more criteria, different from the first set of one or more criteria, is satisfied, wherein the second set of one or more criteria includes a criterion that is satisfied when the state corresponding to the hub device for the one or more accessory devices corresponds to the first state, forgoing display of, via the display generation component, the first notification.

In some embodiments, a computer system configured to communicate with a display generation component and an input device is described. In some embodiments, the computer system comprises one or more processors and memory storing one or more programs configured to be executed by the one or more processors. In some embodiments, the one or more programs includes instructions for: detecting a state corresponding to a hub device for one or more accessory devices; and in response to detecting the state corresponding to the hub device for the one or more accessory devices: in accordance with a determination that a first set of one or more criteria is satisfied, wherein the first set of one or more criteria includes a criterion that is satisfied when the hub device for the one or more accessory devices was manually selected for a network and that the state corresponding to the hub device for the one or more accessory devices corresponds to a first state, displaying, via the display generation component, a first notification; and in accordance with a determination that a second set of one or more criteria, different from the first set of one or more criteria, is satisfied, wherein the second set of one or more criteria includes a criterion that is satisfied when the state corresponding to the hub device for the one or more accessory devices corresponds to the first state, forgoing display of, via the display generation component, the first notification.

In some embodiments, a computer system configured to communicate with a display generation component and an input device is described. In some embodiments, the computer system comprises means for performing each of the following steps: detecting a state corresponding to a hub device for one or more accessory devices; and in response to detecting the state corresponding to the hub device for the one or more accessory devices: in accordance with a determination that a first set of one or more criteria is satisfied, wherein the first set of one or more criteria includes a criterion that is satisfied when the hub device for the one or more accessory devices was manually selected for a network and that the state corresponding to the hub device for the one or more accessory devices corresponds to a first state, displaying, via the display generation component, a first notification; and in accordance with a determination that a second set of one or more criteria, different from the first set of one or more criteria, is satisfied, wherein the second set of one or more criteria includes a criterion that is satisfied when the state corresponding to the hub device for the one or more accessory devices corresponds to the first state, forgoing display of, via the display generation component, the first notification.

In some embodiments, a computer program product is described. In some embodiments, the computer program product comprises one or more programs configured to be executed by one or more processors of a computer system that is in communication with a display generation component and an input device. In some embodiments, the one or more programs include instructions for: detecting a state corresponding to a hub device for one or more accessory devices; and in response to detecting the state corresponding to the hub device for the one or more accessory devices: in accordance with a determination that a first set of one or more criteria is satisfied, wherein the first set of one or more criteria includes a criterion that is satisfied when the hub device for the one or more accessory devices was manually selected for a network and that the state corresponding to the hub device for the one or more accessory devices corresponds to a first state, displaying, via the display generation component, a first notification; and in accordance with a determination that a second set of one or more criteria, different from the first set of one or more criteria, is satisfied, wherein the second set of one or more criteria includes a criterion that is satisfied when the state corresponding to the hub device for the one or more accessory devices corresponds to the first state, forgoing display of, via the display generation component, the first notification.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for managing home hubs, thereby increasing the effectiveness, efficiency, and user satisfaction with such devices. Such processes and interfaces may complement or replace other processes for managing home hubs.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates an electronic device in accordance with some embodiments.

FIG. 5J is a block diagram illustrating an electronic device in accordance with some embodiments.

FIGS. 6A-6H illustrate exemplary user interfaces for managing hub devices in accordance with some embodiments.

FIG. 7 is a flow diagram illustrating a process for displaying a device as an active hub device in accordance with some embodiments.

FIG. 8 is a flow diagram illustrating a process for displaying a notification of a state of hub device in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for managing home hubs. For example, some techniques are for displaying a device as an active hub device. Other techniques are for displaying a notification of a state of hub device in accordance with some embodiments. Such techniques can reduce the cognitive burden on a user who manages home hubs, thereby enhancing productivity. Further, such techniques can reduce processor and battery power otherwise wasted on redundant user inputs.

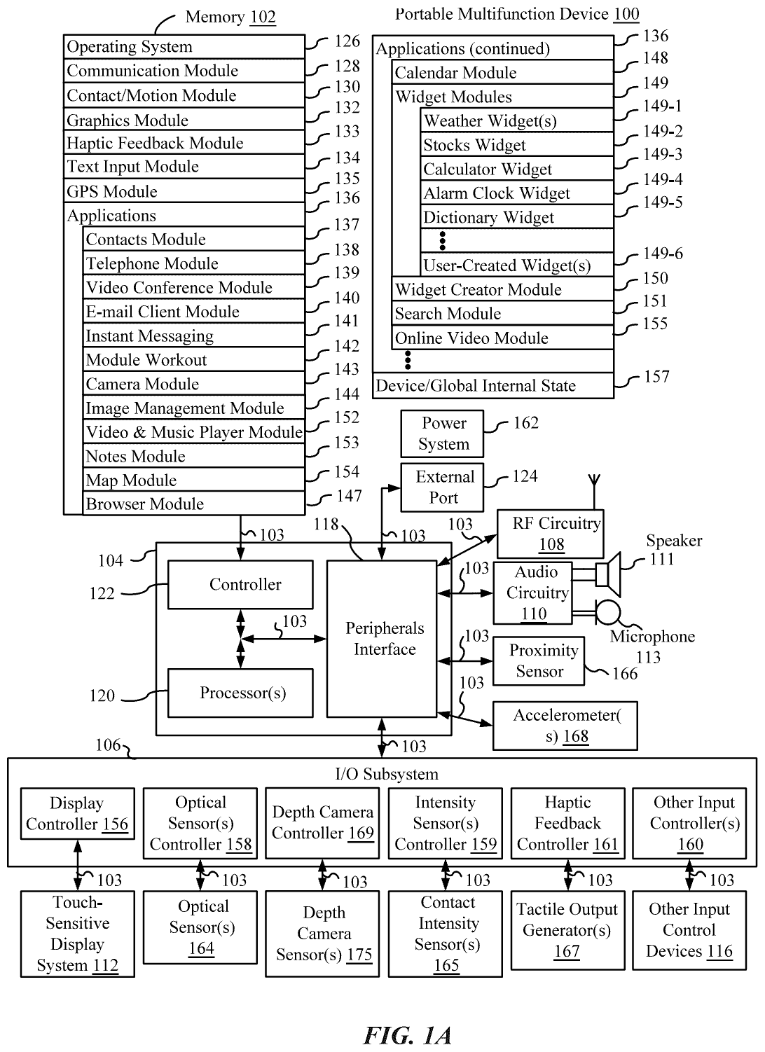

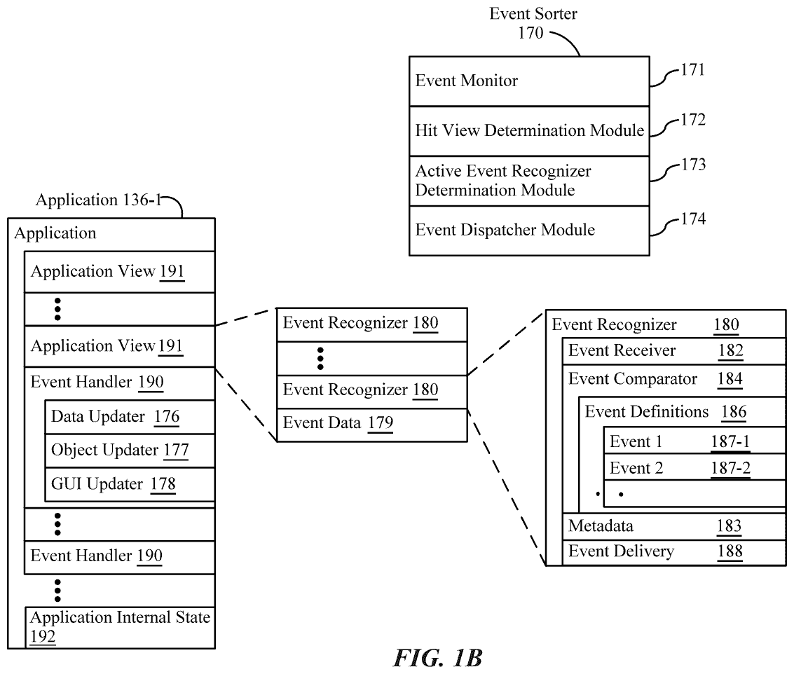

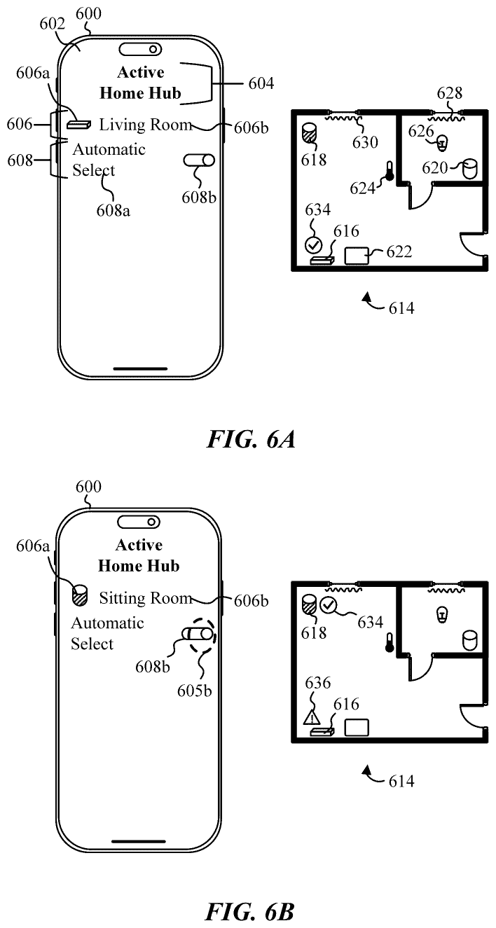

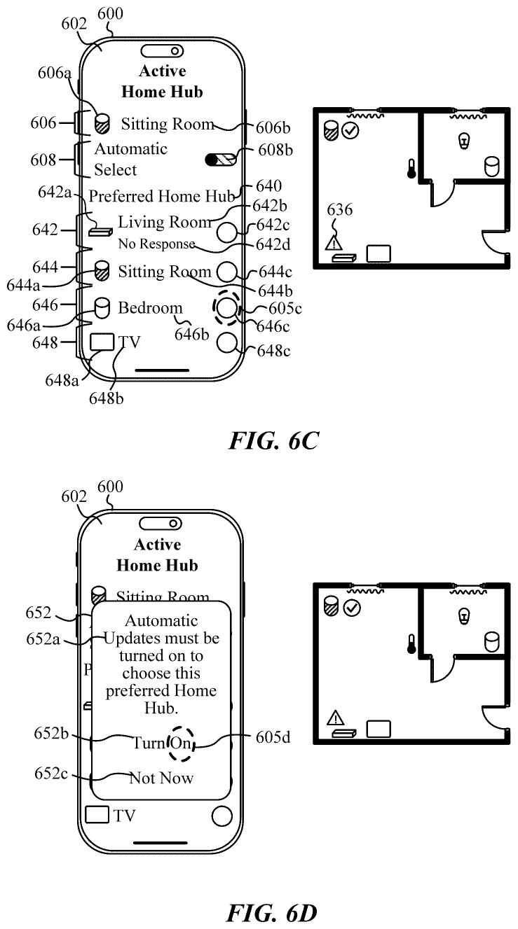

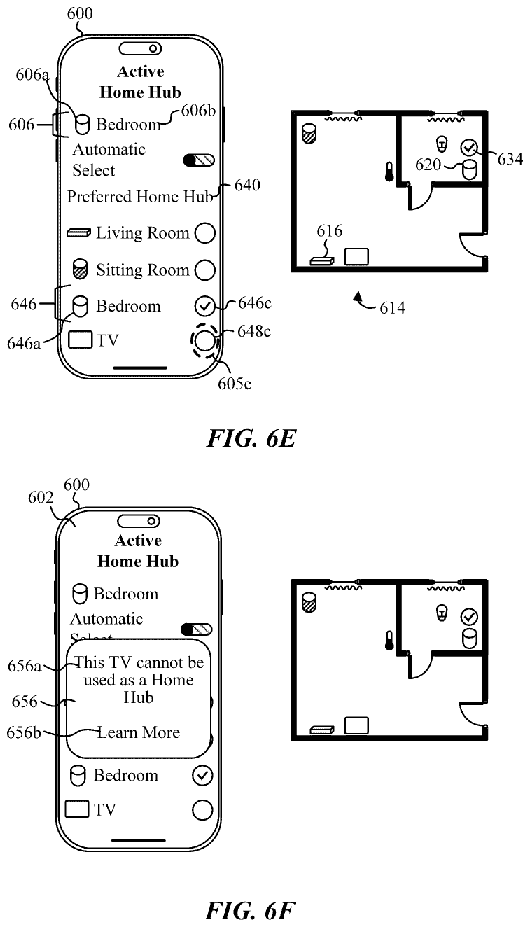

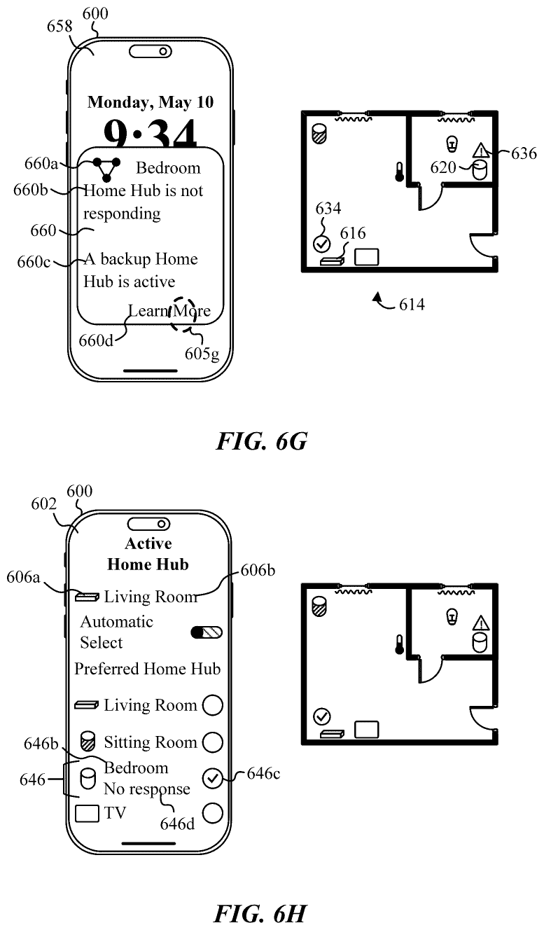

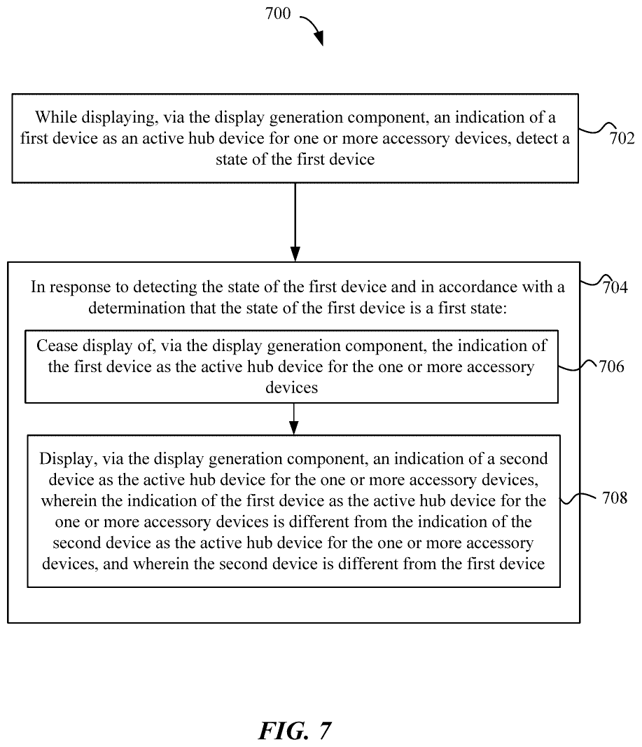

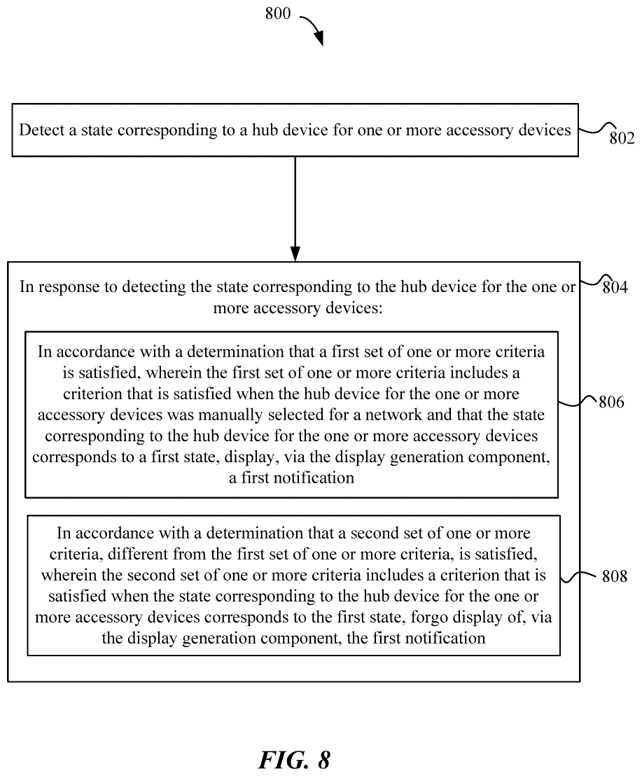

Below, FIGS. 1A-1B, 2, 3A-3G, 4A-4B, and 5A-5J provide a description of exemplary devices for performing the techniques for managing home hubs. FIGS. 6A-6H illustrate exemplary user interfaces for managing hub devices in accordance with some embodiments. FIG. 7 is a flow diagram illustrating a process for displaying a device as an active hub device in accordance with some embodiments. The user interfaces in FIGS. 6A-6H are used to illustrate the processes described below, including the processes in FIG. 7. FIG. 8 is a flow diagram illustrating a process for displaying a notification of a state of hub device in accordance with some embodiments. The user interfaces in FIGS. 6A-6H are used to illustrate the processes described below, including the processes in FIG. 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

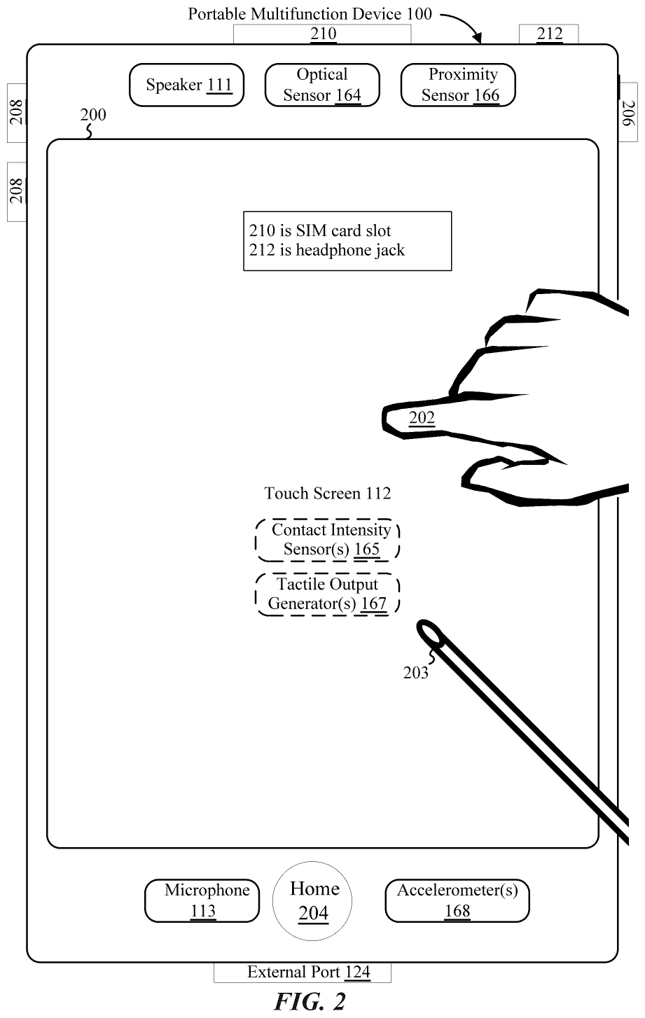

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

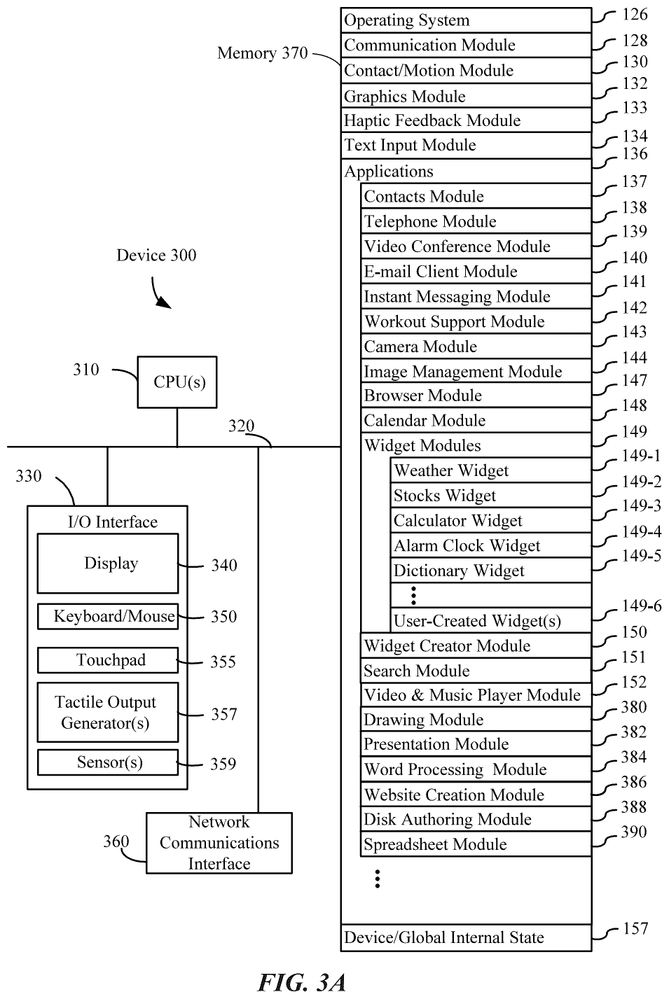

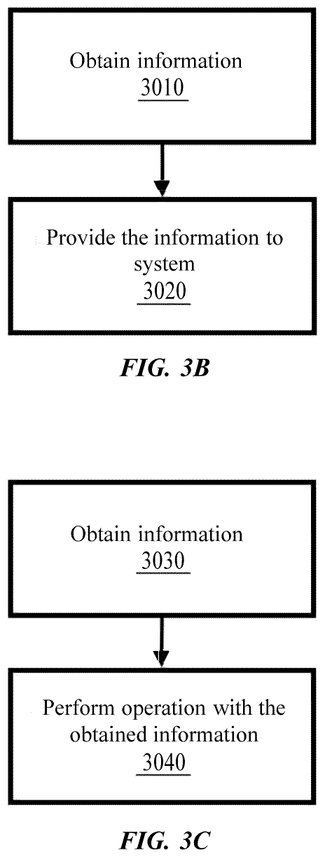

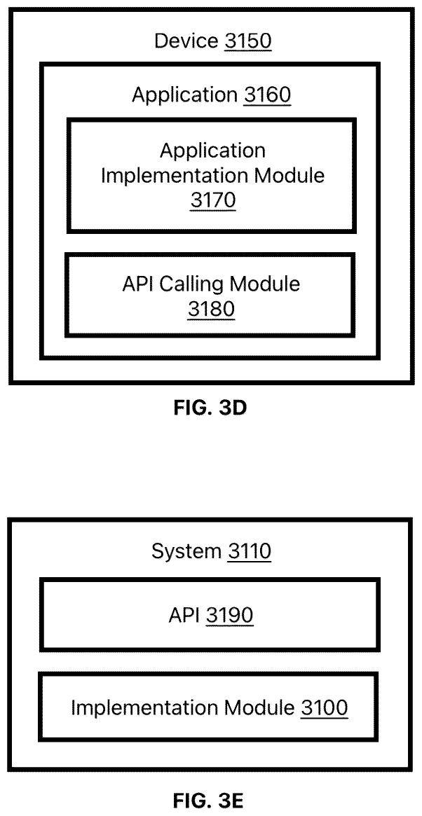

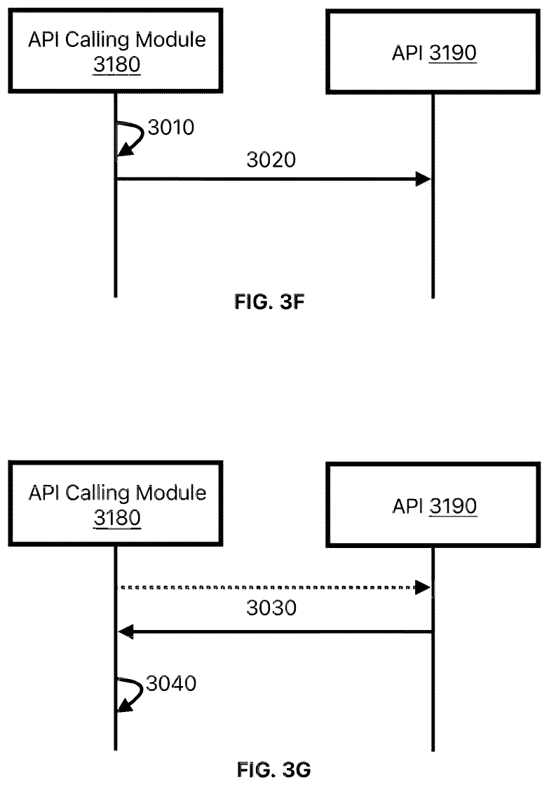

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (arc) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700 and 800 (FIGS. 7 and 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

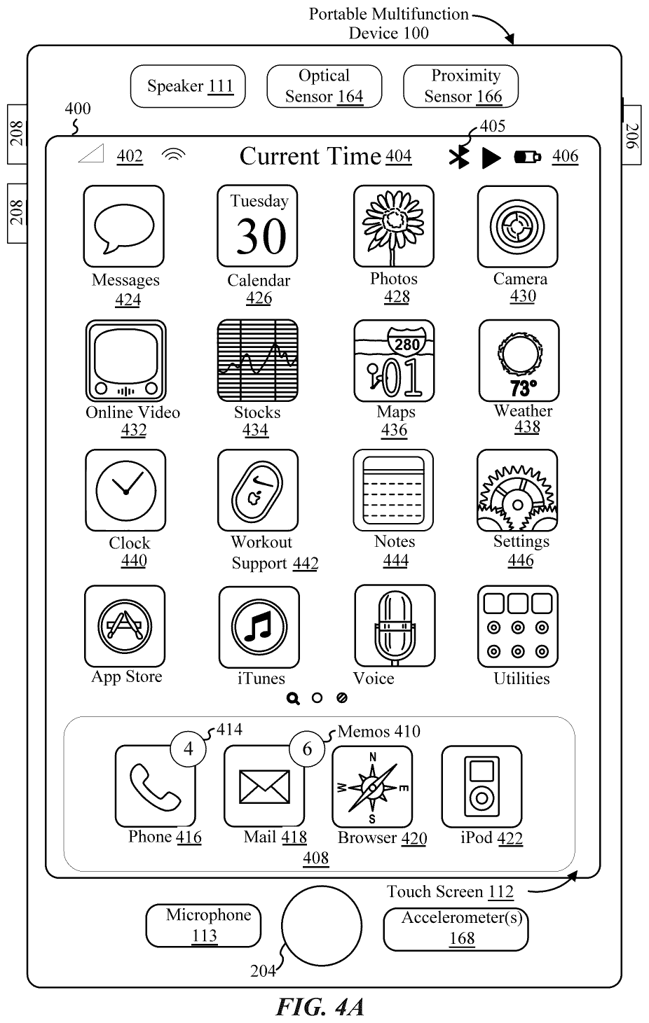

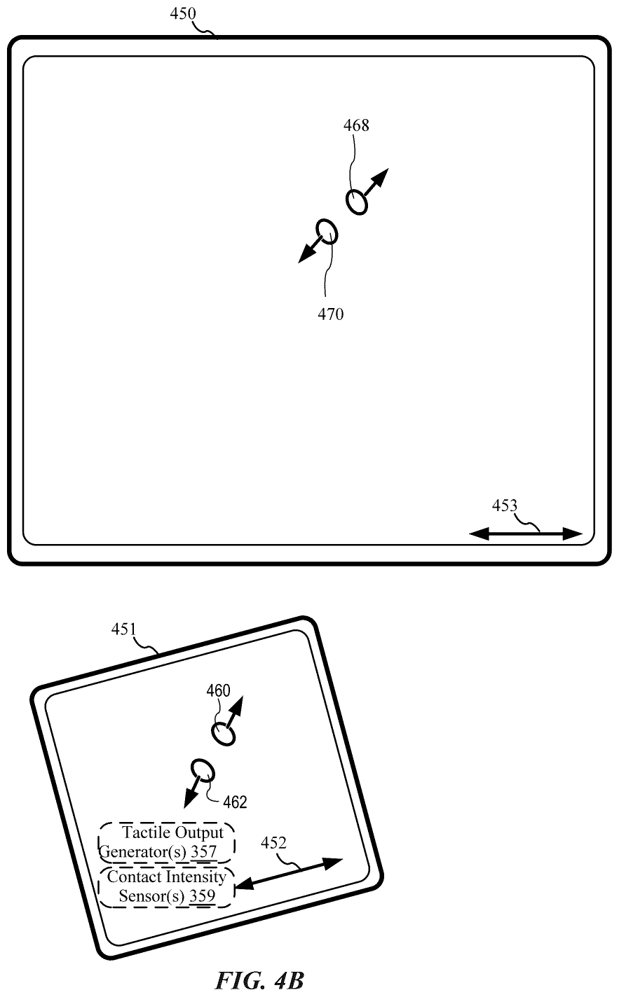

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

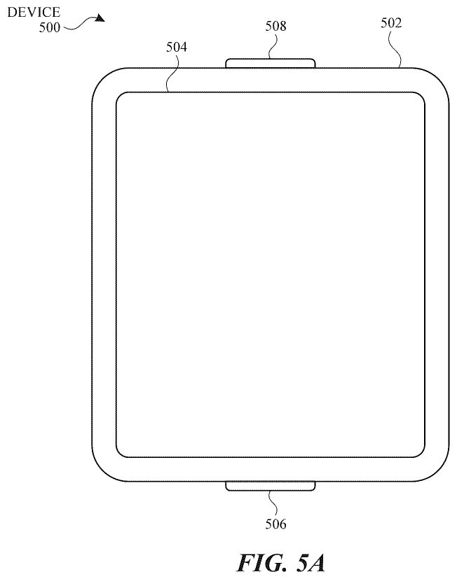

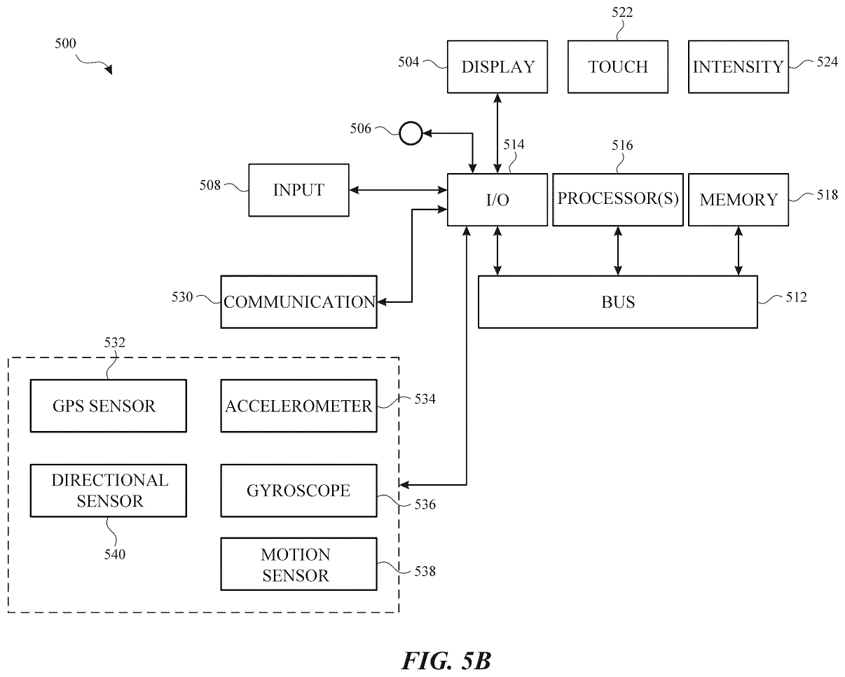

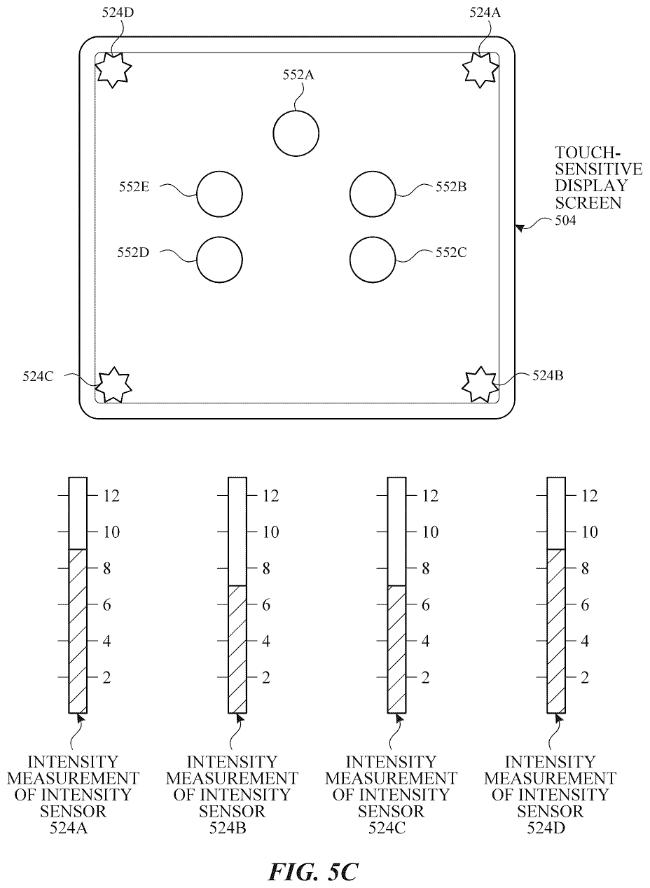

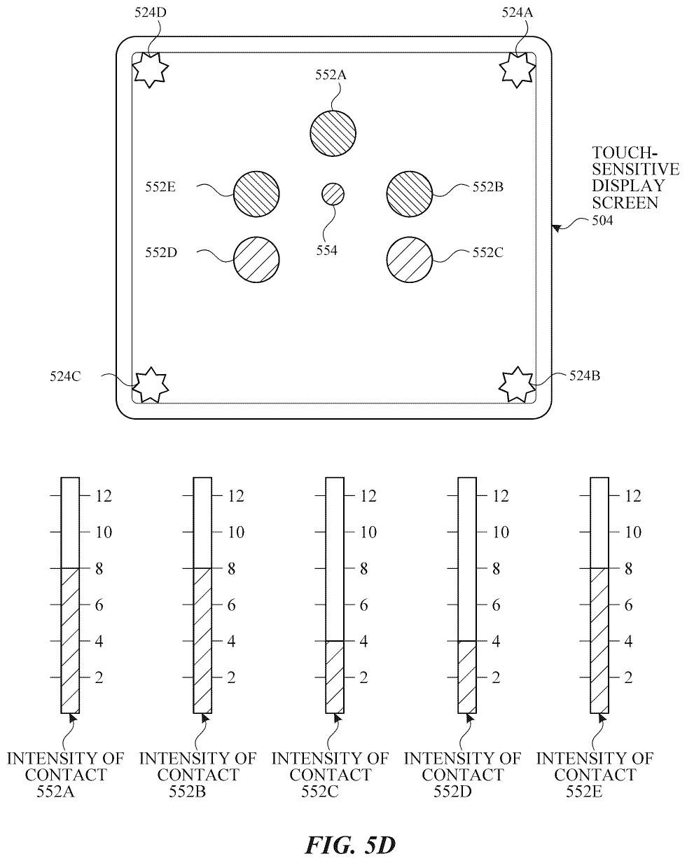

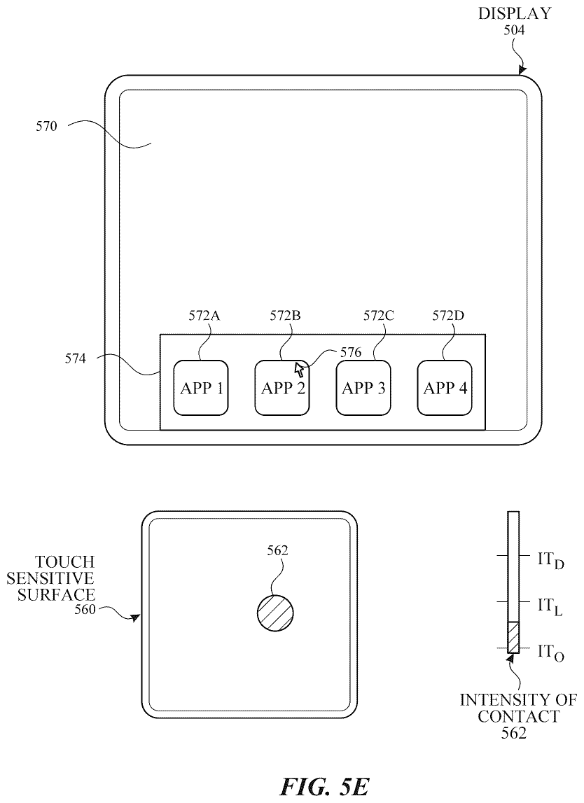

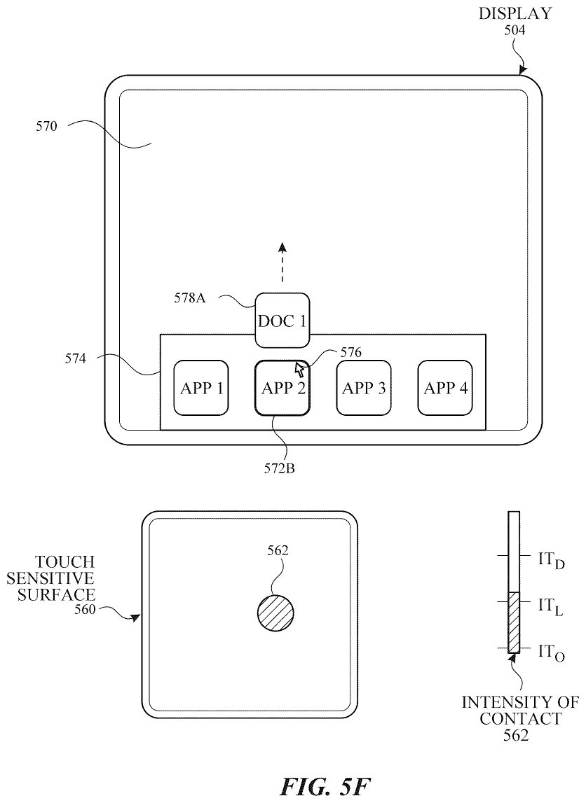

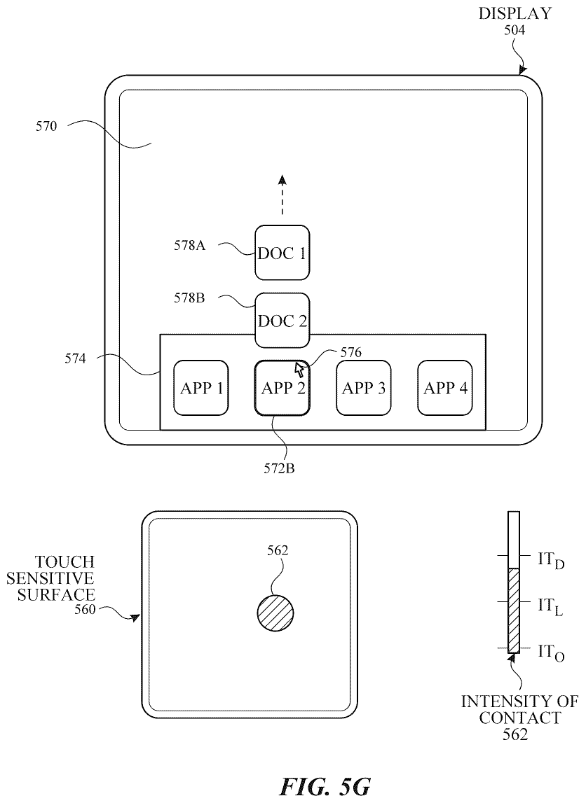

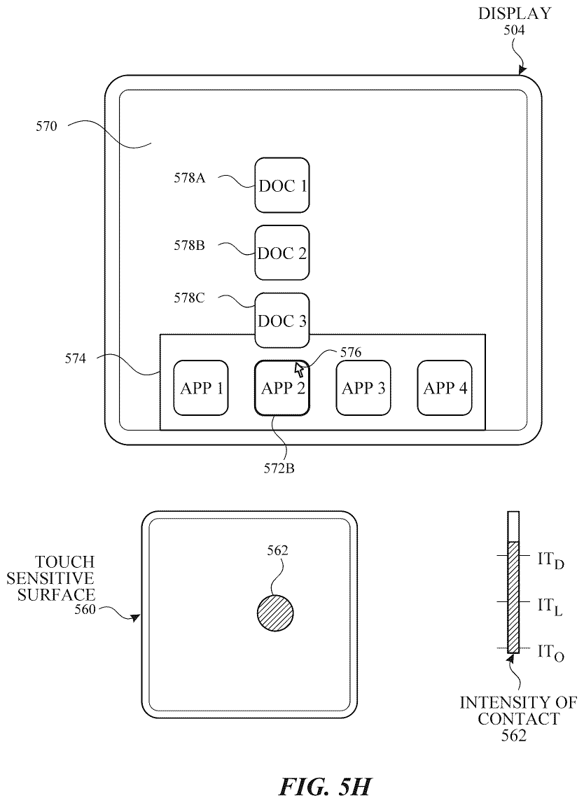

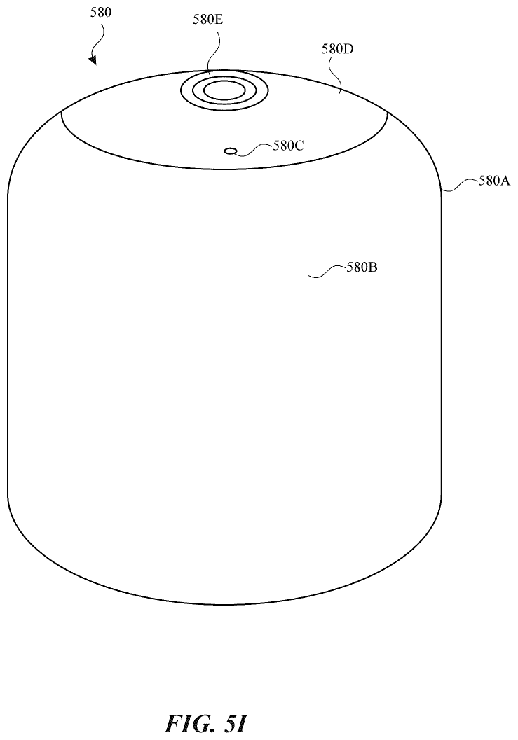

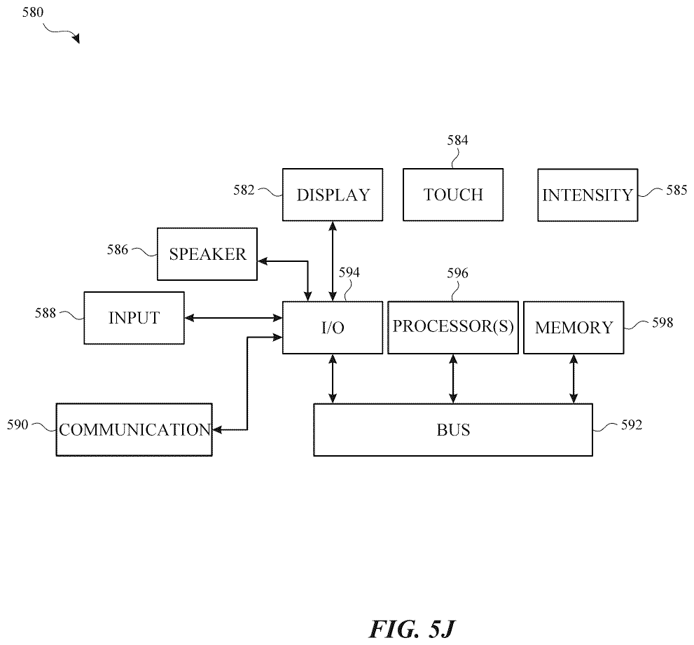

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 800 (FIGS. 7 and 8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For case of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

FIG. 5I illustrates exemplary electronic device 580. Device 580 includes body 580A. In some embodiments, device 580 can include some or all of the features described with respect to devices 100, 300, and 500 (e.g., FIGS. 1A-5B). In some embodiments, device 580 has one or more speakers 580B (concealed in body 580A), one or more microphones 580C, one or more touch-sensitive surfaces 580D, and one or more displays 580E. Alternatively, or in addition to a display and touch-sensitive surface 580D, the device has a touch-sensitive display (also referred to as a touchscreen). As with devices 100, 300, and 500, in some embodiments, touch-sensitive surface 580D (or the touch screen) optionally includes one or more intensity sensors for detecting intensity of contacts (e.g., touches) being applied. The one or more intensity sensors of touch-sensitive surface 580D (or the touchscreen) can provide output data that represents the intensity of touches. The user interface of device 580 can respond to touches based on their intensity, meaning that touches of different intensities can invoke different user interface operations on device 580. In some embodiments, the one or more displays 580E are one or more light-emitting diodes (LEDs). For example, a display can be a single LED, an LED cluster (e.g., a red, a green, and a blue LED), a plurality of discrete LEDs, a plurality of discrete LED clusters, or other arrangement of one or more LEDs. For example, the display 580E can be an array of nine discrete LED clusters arranged in a circular shape (e.g., a ring). In some examples, the one or more displays are comprised of one or more of another type of light-emitting elements.

FIG. 5J depicts exemplary personal electronic device 580. In some embodiments, device 580 can include some or all of the components described with respect to FIGS. 1A, 1B, 3A-3G, and 5A-5B. Device 580 has bus 592 that operatively couples I/O section 594 with one or more computer processors 596 and memory 598. I/O section 594 can be connected to display 582, which can have touch-sensitive component 584 and, optionally, intensity sensor 585 (e.g., contact intensity sensor). In some embodiments, touch-sensitive component 584 is a separate component than display 582. In addition, I/O section 594 can be connected with communication unit 590 for receiving application and operating system data, using Wi-Fi, Bluetooth, near field communication (NFC), cellular, and/or other wireless communication techniques. Device 580 can include input mechanisms 588. Input mechanism 588 is, optionally, a button, in some examples. Input mechanism 588 is, optionally, a microphone, in some examples. Input mechanism 588 is, optionally, a plurality of microphones (e.g., a microphone array).

Electronic device 580 includes speaker 586 for outputting audio. Device 580 can include audio circuitry (e.g., in I/O section 594) that receives audio data, converts the audio data to an electrical signal, and transmits the electrical signal to speaker 586. Speaker 586 converts the electrical signal to human-audible sound waves. The audio circuitry (e.g., in I/O section 594) also receives electrical signals converted by a microphone (e.g., input mechanism 588) from sound waves. The audio circuitry (e.g., in I/O section 594) converts the electrical signal to audio data. Audio data is, optionally, retrieved from and/or transmitted to memory 598 and/or RF circuitry (e.g., in communication unit 590) by I/O section 594.

Memory 598 of personal electronic device 580 can include one or more non-transitory computer-readable storage mediums, for storing computer-executable instructions, which, when executed by one or more computer processors 596, for example, can cause the computer processors to perform the techniques described below, including processes 700 and 800 (FIGS. 7 and 8)). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 580 is not limited to the components and configuration of FIG. 5J, but can include other or additional components in multiple configurations.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6H illustrate exemplary user interfaces for managing a home hub in accordance with some embodiments. The user interfaces in these figures are used to illustrate the processes described below, including the processes in FIGS. 7-8.

The left side of FIGS. 6A-6H illustrate computer system 600 as a smart phone. It should be recognized that computer system 600 can be other types of computer systems such as a smart watch, a tablet, a laptop, a communal device, an accessory, a personal gaming system, a desktop computer, a fitness tracking device, and/or a head-mounted display (HMD) device. In some embodiments, computer system 600 includes and/or is in communication with one or more input devices and/or sensors (e.g., a camera, a LiDAR sensor, a motion sensor, an infrared sensor, a microphone, a touch-sensitive surface, and/or a physical input mechanism such as a button, a rotational mechanism, and/or a slider). It should be recognized that, while some embodiments described herein refer to inputs being touch inputs detected via a touch-sensitive surface, other types of inputs can be used with techniques described herein, such as voice inputs that are detected via one or more microphones and/or air gestures detected via one or more cameras.

At FIGS. 6A-6H, computer system 600 is in communication with a smart home control system. In some embodiments, the smart home control system includes a principal control device (sometimes referred to as a home hub and/or a hub device) and one or more accessories (e.g., a light, a speaker, a television, a camera, a lock, a thermostat, a fan, an appliance, an outlet, a switch, and/or a window covering). In such embodiments, the home hub and the one or more accessories can communicate via one or more networks, such as a local network (e.g., a Wi-Fi network and/or a short-range communication network including a Bluetooth connection) and/or a global network (e.g., the Internet). Computer system 600 can be connected to the one or more networks and/or communicate with the home hub via another network (e.g., a global network such as the Internet) different from the one or more networks. For example, while computer system 600 is located at a location corresponding to the smart home control system, computer system 600 can be connected to the same Wi-Fi network as the home hub. For another example, while computer system 600 is located at a different location than the location corresponding to the smart home control system, computer system 600 can be on a different Wi-Fi network than the home hub. In some embodiments, the home hub manages the one or more accessories, such as coordinating commands and/or tracking status of the one or more accessories. In some embodiments, computer system 600 communicates with an accessory of the one or more accessories via the home hub.

At FIGS. 6A-6H, the smart home control system includes multiple devices that are capable of operating as the home hub, though a limited number of devices (e.g., one or multiple) operate as the home hub at a time. In some embodiments, the devices that are capable of operating as the home hub operate as accessories when not operating as the home hub. For example, a smart speaker that is capable of operating as the home hub operates as a smart speaker in communication with the home hub when the smart speaker is not the home hub. In some embodiments, while an accessory is operating as the home hub, the accessory device can perform both the functions of the home hub and the functions of the accessory. For example, a smart TV that is operating as the home hub can display media content as an accessory and manage operation of the one or more accessories as the home hub. At FIGS. 6A-6H, computer system 600 receives information from the smart home control system about the status of the smart home control system, the home hub, the devices capable of operating as the home hub, and/or the one or more accessories.

The right side of FIGS. 6A-6H include diagram 614, which is a representation of an environment (e.g., a living space, a home, a physical environment, a physical space, and/or a set of one or rooms) including the smart home control system. The representation includes devices capable of operating as the home hub and multiple accessories. Diagram 614 includes representations of three devices capable of operating the home hub, including living room device representation 616 (e.g., a media streaming device in the living room), sitting room device representation 618 (e.g., a smart speaker in the sitting room), and bedroom device representation 620 (e.g., a smart speaker in the bedroom). Diagram 614 also includes representations of accessories, including television representation 622 (e.g., a smart television in the living room), thermostat representation 624 (e.g., a smart thermostat in the sitting room), lights representation 626 (e.g., lights in the bedroom), bedroom curtains representation 628 (e.g., motorized curtains in the bedroom), and sitting room curtains representation 630 (e.g., motorized curtains in the sitting room). It should be recognized that the environment can include more, fewer, and/or different devices than illustrated in FIGS. 6A-6H, including more or fewer devices that are capable of operating as the home hub.

As illustrated in FIG. 6A, computer system 600 displays active hub user interface 602 including user interface label 604 and active hub indicator 606. In some embodiments, user interface label 604 indicates that active hub user interface 602 corresponds to a user interface for indicating which device is currently the home hub. In some embodiments, active hub indicator 606 indicates a particular device that is currently the home hub, including a graphical representation (e.g., active hub icon 606a) of the hub device that is specific to the particular device (e.g., or a type of device of the particular device) and/or a textual representation (e.g., active hub indicator 606b) of the hub device that is specific to the particular device (e.g., assigned manually by a user and/or automatically by a system corresponding to active hub user interface 602). As illustrated in FIG. 6A, user interface label 604 is at the top of active hub user interface 602 and active hub indicator 606 is at an area of active hub user interface 602 below user interface label 604.

At FIG. 6A, computer system 600 receives information that the media streaming device in the living room is operating as the home hub, as indicated by active icon 634 being illustrated next to living room device representation 616 within diagram 614. It should be recognized that active icon 634 is included in diagram 614 for illustrative purposes and ease of discussion. As illustrated in FIG. 6A, in response to receiving the information that the media streaming device in the living room is operating as the home hub, computer system 600 displays active hub name 606b with the text “Living Room” to indicate the device that is operating as the home hub. As illustrated in FIG. 6A, in response to receiving the information that the media streaming device in the living room is operating as the home hub, computer system 600 displays active hub icon 606a with a visual representation of the device operating as the home hub (e.g., a media streaming device). In some embodiments, the user has assigned the media streaming device in the living room a different name. In such embodiments, in response to receiving the information that the media streaming device in the living room is operating as the home hub, computer system 600 displays active hub name 606b with text indicating the assigned name of the living room device. For example, if the user had assigned the name “Stream” to the media streaming device in the living room, computer system 600 displays active hub name 606b with the text indicating the assigned name of the device (e.g., Stream).

As illustrated in FIG. 6A, active hub user interface 602 includes automatic select indicator 608 as occupying an area of active hub user interface 602 below active hub indicator 606. Automatic select indicator 608 includes automatic select control 608b at the right side of automatic select indicator 608 and automatic label 608a with the text “automatic select” at the left side of automatic select indicator 608. As illustrated in FIG. 6A, automatic select control 608b is in the on and/or active position, indicating that automatic select (e.g., automatic selection of a device to operate as the home hub without notifying a user) is on and/or active. It should be recognized that the placement and/or appearance of automatic select indicator 608 is just used as an example and that other positions and/or appearances can be used with techniques described herein. To note, at FIG. 6A, in response to automatic select being on, active hub user interface 602 includes content corresponding to the device operating as the home hub (e.g., active hub indicator 606) without including content corresponding to any other device capable of operating as the home hub.

At FIG. 6B, the media streaming device in the living room is no longer accessible via the smart home control system (e.g., by computer system 600), as indicated by incident icon 636 being illustrated next to living room device representation 616 within diagram 614. In some embodiments, an accessory is no longer accessible via the smart home control system when the accessory stops responding due to loss of power and/or a lost connection of the one or more networks due to signal strength or a network failure. At FIG. 6B the smart speaker in the sitting room begins operating as the home hub, as indicated by active icon 634 being illustrated next to sitting room device representation 618 within diagram 614. In some embodiments, in response to the media streaming device in the living room no longer being accessible and automatic select being on, the smart speaker in the sitting room is automatically selected to operate as the home hub. For example, in response to the media streaming device in the living room no longer being accessible and automatic select being on, computer system 600 and/or another computer system (e.g., a server or a device within the smart home control system) can cause the smart speaker in the sitting room to operate as the home hub without detecting an input (e.g., a user input) via one or more input devices of computer system 600. It should be recognized that the smart speaker in the sitting room can be automatically selected to operate as the home hub for multiple reasons and/or that another device can be selected to operate as the home hub as described further below. At FIG. 6B, computer system 600 receives information that the living room media streaming device is no longer accessible and/or that the smart speaker in the sitting room is operating as the home hub.

As illustrated in FIG. 6B, in response to receiving the information that the smart speaker in the sitting room is operating as the home hub, computer system 600 displays active home name 606b with the text “Sitting Room” and displays active hub icon 606a with a visual representation of the smart speaker in the sitting room. At FIG. 6B, in response to receiving the information that the smart speaker in the sitting room (e.g., not the media streaming device in the living room) is operating as the home hub while automatic select is on, computer system 600 does not display content corresponding to the media streaming device in the living room and instead displays the visual representation of smart speaker 606a.

In some embodiments, in response to receiving the information that the living room media streaming device is no longer accessible and/or that the smart speaker in the sitting room is operating as the home hub while the automatic select is on, computer system 600 does not output a notification corresponding to the living room media streaming device no longer being accessible and/or the smart speaker in the sitting room operating as the home hub. In some embodiments, in response to receiving the information that the living room media streaming device is no longer accessible and/or that the smart speaker in the sitting room is operating as the home hub while the automatic select is off, computer system 600 outputs a notification corresponding to the living room media streaming device no longer being accessible and/or the smart speaker in the sitting room operating as the home hub. At FIG. 6B, computer system 600 detects selection input 605b on automatic select control 608b.

At FIG. 6C, in response to detecting selection input 605b, computer system 600 causes notifications to be sent when changes occur with respect to the home hub of the smart home control system (e.g., that a new device is operating as the home hub). As illustrated in FIG. 6C, in response to detecting selection input 605b, computer system 600 displays automatic select control 608b in an off and/or inactive position. As illustrated in FIG. 6C, in response to detecting selection input 605b, computer system 600 displays list title 640 (e.g., Preferred Home Hub) and a list of devices of the smart home control system. As illustrated in FIG. 6C, list title 640 is below automatic select indicator 608 in active hub user interface 602. List title 640 includes text to inform the user that the list includes devices that the user may choose as the preferred device to operate as the home hub. In some embodiments, the list of devices of the smart home control system are displayed in a preferred order as selected by the smart home control system. For example, the preferred order may be the same order in which the smart home control system selects devices as home hubs when automatic select mode is selected. In some embodiments, computer system 600 orders devices based on a variety of factors such as whether or not a device is plugged into a power source, the device's network connectivity, and/or whether or not the device's software is updated. In some embodiments, computer system 600 updates the order of the devices based on user preference. In such embodiments, computer system 600 changes the displayed order of the selections in response to detected user inputs. For example, in response to detecting selection input 605c, computer system 600 displays third selection 646 at the top of the selections list, under list title 640.

As illustrated in FIG. 6C, the list of devices includes first selection 642 (e.g., corresponding to the media streaming device in the living room), second selection 644 (e.g., corresponding to the smart speaker in the sitting room), third selection 646 (e.g., corresponding to the smart speaker in the bedroom), and fourth selection 648 (e.g., corresponding to the smart television in the living room). It should be recognized that the list of devices can include more, fewer, and/or different devices and/or devices in a different order than illustrated in FIG. 6C. In some embodiments, if the list of devices is larger than computer system 600 can display at one time, computer system 600 displays the list as a scrollable list.

As illustrated in FIG. 6C, each of first selection 642, second selection 644, third selection 646, and fourth selection 648 includes a respective icon (e.g., first selection icon 642a of first selection 642, second selection icon 644a of second selection 644, third selection icon 646a of third selection 646, and fourth selection icon 648a of fourth selection 648) on the left, a respective name (e.g., first selection name 642b of first selection 642, second selection name 644b of second selection 644, third selection name 646b of third selection 646, and fourth selection name 648b of fourth selection 648) in the middle, and a respective selection control (e.g., first selection control 642c of first selection 642, second selection control 644c of second selection 644, third selection control 646c of third selection 646, and fourth selection control 648c of fourth selection 648) on the right. As illustrated in FIG. 6C, active hub 606 includes an icon (e.g., active hub icon 606a) on the left and a respective name (active selection name 606b) on the right. As with active hub name 606b within active hub indicator 606, computer system 600 displays the names with text indicating the device that corresponds to the selection the name is included in. As illustrated in FIG. 6C, in response to second selection 644 corresponding to the smart speaker in the sitting room, computer system 600 displays second selection name 644b with text indicating the smart speaker in the sitting room (e.g., sitting room).

As illustrated in FIG. 6C, in response to receiving the information that the media streaming device in the living room is not accessible (e.g., the media streaming device itself notifies the smart home control system and/or computer system 600 that it is not accessible, another accessory notifies the smart home control system and/or computer system 600 that the media streaming device is not accessible, and/or the smart home control system and/or computer system 600 receives no response from the media streaming device in the living room after a certain period of time trying to contact the media streaming device), computer system 600 displays first response indicator 642d which includes the text “no response” below first selection name 642b. In some embodiments, computer system 600 displays a different indication within first selection 642 to indicate that the media device in the living room is not accessible. For example, in response to receiving the information that the media streaming device in the living room is not accessible, computer system 600 displays an icon similar to incident icon 636 overlayed on first selection icon 642a. In some embodiments, computer system 600 receives information that another device capable of operating as a home hub is not accessible. In such embodiments, computer system 600 displays a corresponding response indicator below the respective selection. For example, in response to computer system 600 receiving the information that the smart speaker in the bedroom is not accessible, computer system 600 displays a response indicator 646d below third selection name 646b, as illustrated below in FIG. 6H. At FIG. 6C, computer system 600 detects selection input 605c at a location corresponding to third selection control 646c. In some embodiments, when a device from the list of devices is determined to be not accessible, the device is moved to the bottom of the list of devices. In some embodiments, when a device from the list of devices is determined to be not accessible, the device is removed from the list of devices.

At FIG. 6D, in response to detecting selection input 605c, computer system 600 determines that the smart speaker in the bedroom does not have automatic updates turned on. As illustrated in FIG. 6D, in response to determining that the smart speaker in the bedroom does not have automatic updates turned on, computer system 600 displays automatic updates user interface 652 overlayed on top of active hub user interface 602. As illustrated in FIG. 6D, computer system 600 displays automatic updates user interface 652 with updates notification 652a at the top, turn on control 652b below updates notification 652a, and not now control 652c at the bottom. As illustrated in FIG. 6D, updates notification 652a includes text to inform the user that automatic updates must be turned on to allow for the selection of the device as the preferred device to operate as the home hub. It should be recognized that other criteria can be required for selecting a device to operate as the home hub and that automatic updates must be turned on is used as an example. At FIG. 6D, computer system 600 detects selection input 605d at a location corresponding to turn on control 652b. In some embodiments, computer system 600 detects a selection input at a location corresponding to not now control 652c. In such embodiments, computer system 600 can cease display of automatic updates user interface 652 and displays active hub user interface 602 as illustrated in FIG. 6C with no device selected as the preferred device to operate as the home hub (or a previously selected device as the preferred device to operate as the home hub when another device is previously selected).

At FIG. 6E, in response to detecting selection input 605d, computer system 600 ceases display of automatic updates user interface 652. At FIG. 6E, in response to detecting selection input 605d, computer system 600 causes the smart speaker in the bedroom to operate as the home hub and/or the preferred home hub. Also illustrated in FIG. 6E, in response to detecting selection input 605d, computer system 600 displays third selection control 646c with a check mark, indicating that the smart speaker in the bedroom is selected as the preferred device to operate as the home hub. In some embodiments, in response to detecting selection input 605d, computer system 600 displays third selection control 646c and/or third selection 646 in a different way to indicate that the smart speaker in the bedroom is selected as the preferred device to operate as the home hub. For example, in response to detecting selection input 605d, computer system 600 displays the contents of third selection 646 as larger than the contents of the other selections. For another example, in response to detecting selection input 605d, computer system 600 displays third selection control 646c in a different color than computer system 600 displays third selection control 646c when not selected.

At FIG. 6E, the smart speaker in the bedroom is operating as the home hub, as indicated by active icon 634 being illustrated next to bedroom device representation 620 within diagram 614. At FIG. 6E, computer system 600 receives information that the smart speaker in the bedroom is operating as the home hub. As illustrated in FIG. 6E, in response to receiving the information that the smart speaker in the bedroom is operating as the home hub, computer system 600 displays active hub name 606b with the text “Bedroom” and active hub icon 606a with the same representation of the smart speaker as within third selection icon 646a. At FIG. 6E, the media streaming device in the living room begins responding as indicated by the lack of incident icon 636 being illustrated next to living room device representation 616. At FIG. 6E, computer system 600 receives information that the media streaming device in the living room is accessible. Computer system 600 displays the media streaming device in the living room at the top of the list of devices, however, since computer system 600 is not in an automatic select mode the user's selection from FIG. 6C (the smart speaker in the bedroom) is selected as the home hub. At FIG. 6E, in response to receiving the information that the media streaming device in the living room is accessible, computer system 600 ceases display of first response indicator 642d.

In some embodiments, the smart speaker in the bedroom has automatic updates turned on, causing computer system 600 to not display automatic updates user interface 652 in response to detecting selection input 605c. In such embodiments, in response to detecting selection input 605c, computer system 600 displays third selection control 646c with a check mark, indicating that the smart speaker in the bedroom is selected as the preferred device to operate as the home hub, as displayed in FIG. 6E. Also in such embodiments, in response to detecting selection input 605c, computer system 600 causes the smart speaker in the bedroom to operate as the preferred home hub device and displays active hub indicator 606 as displayed in FIG. 6E. At FIG. 6E, computer system 600 detects selection input 605e at a location corresponding to fourth selection control 648c.

As illustrated in FIG. 6F, in response to detecting selection input 605e, computer system 600 display usability user interface 656 overlayed onto active hub user interface 602. As illustrated in FIG. 6F, computer system 600 displays usability user interface 656 with usability indicator 656a and learn more control 656b. Usability indicator 656a includes text identifying the device to the user and text to inform the user that the device cannot operate as the home hub. For example, the smart television in the living room can have an earlier version than required to support operating as the home hub. It should be recognized that other criteria can be used to determine that a device cannot operate as the home hub. In some embodiments, computer system 600 detects a selection input at a location corresponding to learn more control 656b, resulting in computer system 600 displaying a user interface with information about the requirements for devices to operate as the home hub.

At FIG. 6G, at a time after computer system 600 displays usability user interface 656, the smart speaker in the bedroom stops responding and becomes not accessible, as indicated by incident icon 636 being illustrated next to bedroom device representation 620 within diagram 614. At FIG. 6G, computer system 600 receives information that the smart speaker in the bedroom is not accessible. At FIG. 6G, in response to the smart speaker in the bedroom (e.g., the preferred device to operate as the home hub) not being accessible, the media streaming device in the living room is selected to operate as the home hub. At FIG. 6G, the media streaming device in the living room is operating as the home hub, as indicated by active icon 634 next to living room device representation 616 within diagram 614. At FIG. 6G, computer system 600 receives information that the media streaming device in the living room is operating as the home hub. In some embodiments, the media streaming device in the living room was not selected by the user to be operating as the home hub. In some embodiments, in response to the smart speaker in the bedroom not being accessible, a different device (e.g., the smart speaker in the sitting room) is selected to operate as the home hub.

As illustrated in FIG. 6G, computer system 600 displays lock screen 658. At FIG. 6G, in response to receiving the information that the smart speaker in the bedroom (e.g., the preferred device to operate as the home hub) is not being accessible, computer system 600 displays backup notice user interface 660 overlayed on top of lock screen 658. In some embodiments, backup notice user interface 660 is overlayed on an application the user is actively using other than the home application. In some embodiments backup user interface 660 is displayed when a device not selected by the user becomes not accessible. In some embodiments backup user interface 660 is displayed only when a home hub selected by the user becomes not accessible. As illustrated in FIG. 6G, computer system 600 displays backup notice user interface 660 with network icon 660a, not accessible indicator 660b, backup hub indicator 660c, and learn control 660d. Not accessible indicator 660b includes text informing the user that a device that was operating as the home hub is not accessible and includes text identifying the device that was operating as the home hub. It should be recognized that not accessible indicator 660b can include different amounts data of regarding the problem with Home Hub and/or trouble shooting procedures to address the issue. Backup hub indicator 660c includes text informing the user that a different device other than the nonresponsive device (e.g., a backup device) is operating as the home hub. In some embodiments, backup hub indicator 660c includes text identifying the device that is operating as the home hub (e.g., living room). It should be recognized that accessible backup hub indicator 660c can include different amounts data of regarding the new Home Hub such as an IP address, the status of the Home Hub, and/or an alert that switch to the Home Hub was executed.

In some embodiments, in response to receiving the information that the device selected by the user to be the preferred device operating as the home hub is not accessible when automatic select is off, computer system 600 outputs a notification (e.g., displays backup notice user interface 660), which is different from how computer system 600 responds when automatic select is on (e.g., forgoing output of a notification). In some embodiments, when automatic select is on or off, in response to receiving the information that none of the devices that are capable of operating as a home hub are accessible, computer system 600 outputs a notification. In some embodiments, computer system 600 outputting a notification includes outputting sound and/or haptic feedback. For example, in response to receiving the information that none of the devices that are capable of operating as a home hub are accessible, computer system 600 displays a notification overlaying lock screen 658, outputs a horn noise, and/or vibrates.

In some embodiments, in response to receiving the information that the device selected by the user to be the preferred device operating as the home hub is not accessible, computer system 600 outputs a notification while displaying a user interface other than a lock screen user interface. For example, in response to receiving the information that that the device selected by the user to be the preferred device operating as the home hub is not accessible, computer system 600 displays backup notice user interface 660 overlayed on a home screen. In some embodiments, in response to receiving the information that the device selected by the user to be the preferred device operating as the home hub is not accessible while displaying a user interface other than a lock screen user interface, computer system 600 displays a smaller notification overlaying the user interface than backup notice user interface 660. For example, in response to receiving the information that that the device selected by the user to be the preferred device operating as the home hub is not accessible, computer system 600 displays a rectangle with text informing the user that an alternate device has taken over operating as home hub overlaying a small portion of a media player user interface. At FIG. 6G, computer system 600 detects selection input 605g at a location corresponding to more control 660d.

At FIG. 6H, in response to detecting selection input 605g, computer system 600 ceases display of backup notice user interface 660. As illustrated in FIG. 6H, in response to detecting selection input 605g, computer system 600 displays active hub user interface 602 and ceases display of lock screen 658. Also illustrated in FIG. 6H, in response to receiving the information that the bedroom smart speaker is not accessible, computer system 600 displays third selection response indicator 646d with the text “no response” below third selection name 646b. As illustrated in FIG. 6H, computer system 600 continues to display third selection control 646c with a check mark to indicate that the smart speaker in the bedroom is still selected as the preferred device to operate as the home hub while the computer system 600 receives information that the smart speaker in the bedroom is not accessible.

As illustrated in FIG. 6H, in response to receiving the information that the media streaming device in the living room is operating as the home hub, computer system 600 displays active hub icon 606a with a visual representation of the media streaming device in the living room and computer system 600 displays active hub name with the text “living room.” In some embodiments, at a time after receiving the information that the smart speaker in the bedroom is not accessible, computer system 600 receives the information that the smart speaker in the bedroom is accessible and, as the preferred device to operate as the home hub, is operating as the home hub. In such embodiments, computer system 600 displays active hub user interface 602 as computer system displayed active hub user interface 602 in FIG. 6E.

FIG. 7 is a flow diagram illustrating a process (e.g., process 700) for displaying a device as an active hub device in accordance with some embodiments. Some operations in process 700 are, optionally, combined, the orders of some operations are, optionally, changed, and some operations are, optionally, omitted.

As described below, process 700 provides an intuitive way for displaying a device as an active hub device. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) that is in communication with a display generation component (e.g., a display screen, a projector, and/or a touch-sensitive display). In some embodiments, the computer system is a phone, a watch, a tablet, a fitness tracking device, a wearable device, an accessory, a speaker, a light, a head-mounted display, and/or a personal computing device.

While displaying, via the display generation component, an indication (e.g., 606) (e.g., indicator graphic, text, and/or icon) of a first device (e.g., an accessory, a phone, a watch, a tablet, a fitness tracking device, a wearable device, a computer system, a smart tv, a head-mounted display, a personal computing device, a smart speaker, a smart home controller, a desktop, a laptop, a smart appliance, and/or a device that stays in the same location) as an active (e.g., selected, current, operating, main and/or master) hub device (e.g., network device, resident device, smart home hub controller, network switch, repeater, and/or concentrator) for one or more accessory devices (e.g., a watch, a wearable device, a smart speaker, a smart TV, a smart appliance, a light, a head-mounted display, and/or a personal computing device) (and/or an indication that the first device is the active hub device for the one or more accessory devices) (e.g., within a user interface), the computer system detects (702) (e.g., via a communication from the first device, via a communication from an accessory device of the one or more accessory devices, via a communication from a server, and/or based on lack of a communication received from the first device and/or an accessory device of the one or more accessory devices) a state (e.g., operation state, power state, connectivity state, and/or communication state) of the first device. In some embodiments, detecting the state includes sending a communication to the first device and not receiving a communication from the first device within a predetermined period of time. In some embodiments, detecting the state includes receiving a communication from the first device. In some embodiments, detecting the state includes receiving a communication from an accessory device of the one or more accessory devices. In some embodiments, the same location includes a same vicinity, a same area, a same room, and/or a same building.

In response to (704) detecting the state of the first device and in accordance with a determination that a first set of one or more criteria (e.g., that the active hub device for the one or more accessory devices is configured to be selected according to a first mode and/or one or more other criterions) is satisfied, wherein the first set of one or more criteria includes a first criterion that is satisfied when the state of the first device is a first state (e.g., 636) (e.g., an error state, a fault state, a malfunction state, an inactive state, and/or an off state), the computer system ceases (706) (e.g., as described with respect to FIG. 6B) display of, via the display generation component, the indication of the first device as the active hub device for the one or more accessory devices (e.g., within the user interface). In some embodiments, the first state is a state indicating that the first device does not have updated software. In some embodiments, the first state is a state indicating that the first device is turned off. In some embodiments, the first state is a state indicating that the first device is not operating properly. In some embodiments, the first state is a state indicating that the first device is not communicating with the computer system and/or an accessory device of the one or more accessory devices. In some embodiments, the first state is a state indicating that the first device has a low and/or limited connectivity to a network, such as a home network in which a subset of the one or more accessory devices are also connected. In some embodiments, the first state is a state indicating that the first device has no connectivity to a network, such as a home network in which a subset of the one or more accessory devices are also connected. In some embodiments, the first state is a state indicating that the first device is not powered properly. In some embodiments, the first state is a state indicating that a power source of the first device is not properly powering the first device. In some embodiments, the first state is a state indicating that the first device is in a sleep mode and/or standby mode.

In response to (704) detecting the state of the first device and in accordance with the determination that the first set of one or more criteria is satisfied, wherein the first set of one or more criteria includes the first criterion that is satisfied when the state of the first device is the first state, the computer system displays (708), via the display generation component, an indication (e.g., 606 as described with respect to FIG. 6B) (e.g., graphic, text, and/or icon) (and/or an identification) of a second device (e.g., an accessory, a phone, a watch, a tablet, a fitness tracking device, a wearable device, a computer system, a smart tv, a head-mounted display, a personal computing device, a smart speaker, a smart home controller, a desktop, a laptop, a smart appliance, and/or a device that stays in the same location) as the active hub device for the one or more accessory devices (and/or an indication that the second device is the active hub device for the one or more accessory devices) (e.g., within the user interface), wherein the indication (e.g., a graphic, a text, and/or an icon) of the first device as the active hub device for the one or more accessory devices is different from the indication of the second device as the active hub device for the one or more accessory devices, and wherein the second device is different from the first device. In some embodiments, in response to detecting the state of the first device and in accordance with a determination that the state of the first device is a second state (e.g., a functioning state, a non-error state, a non-malfunction state, an active state, and/or an on state) different from the first state, the computer system maintains display of the indication of the first device as the active hub device for the one or more accessory devices without displaying the indication of the second device as the active hub device for the one or more accessory devices. In some embodiments, the first mode is an automatic selection mode that causes a notification and/or an indication (e.g., the indication of the second device as the active hub device for the one or more accessory devices) to be displayed (e.g., via the display generation component) when a current device is no longer able to be the active home hub and (1) there are no other devices able to be the active home hub and/or (2) another device is able to and/or has become the active home hub. Depending on a state of a first device and a state of a second device, ceasing display of an indication of the first device as an active hub device and displaying an indication of the second device as the active hub device allows the computer system to provide an indication of the active hub device after the active hub device has switched from one device to another, thereby providing improved visual feedback to the user and/or performing an operation when a set of conditions has been met without requiring further user input.

In some embodiments, the indication of the first device as the active hub device for the one or more accessory devices includes an identification (e.g., 606b as described with respect to FIG. 6A) (e.g., an IP address, a MAC address, a serial number, a device name, a device identifier, and/or a corresponding user account) of the first device (and/or an icon or other graphical representation corresponding to the first device). An indication of a first device as an active hub device including an identification of the first device allows the computer system to identify a device serving as the active hub device, thereby providing improved visual feedback to the user and/or performing an operation when a set of conditions has been met without requiring further user input.

In some embodiments, the indication (e.g., 606b as described with respect to FIG. 6B) of the second device as the active hub device for the one or more accessory devices includes an identification (e.g., an IP address, a MAC address, a serial number, a device name, a device identifier, and/or a corresponding user account) of the second device (and/or an icon or other graphical representation corresponding to the second device). An indication of a second device as an active hub device including an identification of the second device allows the computer system to identify a device serving as the active hub device, thereby providing improved visual feedback to the user and/or performing an operation when a set of conditions has been met without requiring further user input.

In some embodiments, in response to detecting the state of the first device (and/or while displaying an identification of the second device) and in accordance with the determination that the first set of or more criteria is satisfied, the computer system forgoes (e.g., as described with respect to FIG. 6B) (and/or ceases) display of, via the display generation component, an identification of the first device (e.g., within the user interface). In some embodiments, forgoing display of the identification of the first device occurs in conjunction with (e.g., concurrently, after, and/or before) displaying the indication of the second device as the active hub device for the one or more accessory devices. Forgoing display of an identification of a first device in response to detecting a state of the first device allows the computer system to minimize distractions to a user based on the user's preference, thereby providing improved visual feedback to the user and/or performing an operation when a set of conditions has been met without requiring further user input.

In some embodiments, the first set of one or more criteria includes a second criterion that is satisfied when notification (and/or selection and/or display) of the active hub device (and/or the user interface) is configured to occur in a first manner (e.g., as described with respect to FIG. 6A) (e.g., display an identification of the active hub device without displaying an identification of one or more other devices that are not currently the active hub device). In some embodiments, before (and/or while) detecting the state of the first device (and/or while displaying an identification of the first device) and in accordance with a determination that the second criterion is satisfied, the computer system forgoes (e.g., as described with respect to FIG. 6A) display of, via the display generation component, an identification of the second device (e.g., within the user interface). In some embodiments, the computer system forgoes display of, via the display generation component, the identification of the second device while the second device is not the active hub device for the one or more accessory devices. In some embodiments, the computer system displays, via the display generation component, the identification of the second device while the second device is the active hub device for the one or more accessory devices. Forgoing display of an identification of a second device before detecting a state of the first device allows the computer system to minimize distractions to a user based on the user's preference, thereby providing improved visual feedback to the user and/or performing an operation when a set of conditions has been met without requiring further user input.

In some embodiments, before detecting the state of the first device (and/or while displaying an identification of the first device) and in accordance with a determination that a third criterion, different from the first criterion, is satisfied, wherein the third criterion is satisfied when notification (and/or selection and/or display) of the active hub device (and/or the user interface) is configured to occur in a second manner (e.g., as described with respect to FIG. 6C) (e.g., display (1) an identification of the active hub device and (2) an identification of one or more other devices that are not currently the active hub device) (e.g., different from the first manner), the computer system displays, via the display generation component, an identification (e.g., 606b as described with respect to FIG. 6C) of the second device (e.g., as a first option for the active hub device for the one or more accessory devices) (e.g., within the user interface). In some embodiments, before detecting the state of the first device and in accordance with the determination that the third criterion is satisfied, the computer system concurrently displays, via the display generation component, the identification of the second device (e.g., as the first option for the active hub device for the one or more accessory devices) and an identification of a third device, different from the first device and the second device, as a second option, different from the first option for the active hub device for the one or more accessory devices. Displaying an identification of a second device before detecting a state of a first device allows the computer system to identify devices that may serve as an active hub device, thereby providing improved visual feedback to the user and/or performing an operation when a set of conditions has been met without requiring further user input.

In some embodiments, before detecting the state of the first device (and/or while displaying an identification of the first device) and in accordance with a determination that a third criterion, different from the first criterion, is satisfied, wherein the third criterion is satisfied when notification (and/or selection and/or display) of the active hub device (and/or the user interface) is configured to occur in a second manner (e.g., as described with respect to FIG. 6C) (e.g., display (1) an identification of the active hub device and (2) an identification of one or more other devices that are not currently the active hub device) (e.g., different from the first manner), the computer system displays, via the display generation component, an identification (e.g., 642a as described with respect to FIG. 6C) of the first device (e.g., as a third option, different from the first option and the second option, for the active hub device for the one or more accessory devices) (e.g., within the user interface) that is separate from the indication of the first device as the active hub device for the one or more accessory devices. In some embodiments, before detecting the state of the first device (and/or while displaying an identification of the first device) and in accordance with the determination that the third criterion is satisfied, the computer system displays, via the display generation component, an indication that the third option is selected. In some embodiments, before detecting the state of the first device (and/or while displaying an identification of the first device) and in accordance with the determination that the third criterion is satisfied, the computer system displays, via the display generation component, an indication that the third option is not selected. Displaying an identification of a first device that is separate from an indication of the first device as an active hub device before detecting a state of the first device allows the computer system to identify devices that may serve as an active hub device, thereby providing improved visual feedback to the user and/or performing an operation when a set of conditions has been met without requiring further user input.

In some embodiments, in response to detecting the state of the first device and in accordance with a determination that a second set of one or more criteria (e.g., that the active hub device for the one or more accessory devices is configured to be selected according to a first mode and/or one or more other criterions), different from the first set of one or more criteria, is satisfied, wherein the second set of one or more criteria includes a criterion that is satisfied when the state of the first device is the first state (e.g., 636), the computer system ceases (e.g., as described with respect to FIG. 6E) display of, via the display generation component, the indication of the first device as the active hub device for the one or more accessory devices. In some embodiments, in response to detecting the state of the first device and in accordance with the determination that the second set of one or more criteria, different from the first set of one or more criteria, is satisfied, wherein the second set of one or more criteria includes the criterion that is satisfied when the state of the first device is the first state, the computer system displays (e.g., as described with respect to FIG. 6E), via the display generation component, an indication (e.g., indicator graphic, text, and/or icon) (and/or identification) of a third device (e.g., an system, a smart tv, a head-mounted display, a personal computing device, a smart speaker, a smart home controller, a desktop, a laptop, a smart appliance, and/or a device that stays in the same location) as the active hub device for the one or more accessory devices (e.g., within the user interface), wherein the indication of the third device as the active hub device for the one or more accessory devices is different from the indication of the first device as the active hub device for the one or more accessory devices and the indication of the second device as the active hub device for the one or more accessory devices, and wherein the third device is different from the first device and the second device. In some embodiments, while displaying the indication of the second device as the active hub device for the one or more accessory devices (e.g., within the user interface), the computer system detects (e.g., via a communication from the second device, via a communication from an accessory device of the one or more accessory devices, via a communication from a server, and/or based on lack of a communication received from the second device and/or an accessory device of the one or more accessory devices) a state (e.g., operation state, power state, connectivity state, and/or communication state) of the second device. In some embodiments, in response to detecting the state of the second device and in accordance with a determination that the second set of one or more criteria is satisfied, the computer system ceases display of, via the display generation component, the indication of the second device as the active hub device for the one or more accessory devices (e.g., within the user interface). In some embodiments, in response to detecting the state of the second device and in accordance with the determination that the second set of one or more criteria is satisfied, the computer system displays, via the display generation component, the indication of the third device as the active hub device for the one or more accessory devices (e.g., within the user interface). In some embodiments, the same location includes a same vicinity, a same area, a same room, and/or a same building. Ceasing display of an indication of a first device as an active hub device and displaying an indication of a third device as the active hub device in response to detecting a state of the first device allows the computer system to identify a device serving as the active hub device, thereby providing improved visual feedback to the user and/or performing an operation when a set of conditions has been met without requiring further user input.

In some embodiments, the computer system (e.g., 600) is in communication with one or more input devices (e.g., a camera, a depth sensor, a microphone, a hardware input mechanism, a rotatable input mechanism, a heart monitor, a temperature sensor, and/or a touch-sensitive surface). In some embodiments, while displaying (e.g., 646 as described with respect to FIG. 6C), via the display generation component, an identification of a fourth device (e.g., an accessory, a phone, a watch, a tablet, a fitness tracking device, a wearable device, a computer system, a smart tv, a head-mounted display, a personal computing device, a smart speaker, a smart home controller, a desktop, a laptop, a smart appliance, and/or a device that stays in the same location) (e.g., within the user interface) different from the first device and the second device (and/or the third device) (and/or while displaying the indication of the first device as the active hub device for the one or more accessory devices and/or the indication of the second device as the active hub device for the one or more accessory devices), the computer system detects, via the one or more input devices, an input (e.g., 605C) (e.g., a selection input and/or a non-selection input) corresponding to (e.g., directed to, at a location of, related to and/or associated with) the fourth device (and/or the identification of the fourth device). In some embodiments, the input corresponding to the fourth device includes a tap input directed to a user-interface element indicating whether the fourth device is selected as a preferred option to be the active hub device for the one or more accessory devices. In some embodiments, in response to detecting the input corresponding to the fourth device, the computer system displays (e.g., 606 as described with respect to FIG. 6E), via the display generation component, an indication (e.g., an indicator graphic, a text, and/or an icon) (within the user interface) of the fourth device as the active hub device for the one or more accessory devices. In some embodiments, the same location includes a same vicinity, a same area, a same room, and/or a same building. While displaying an identification of a fourth device, detecting an input corresponding to the fourth device and, in response, displaying an indication of the fourth device as the active hub device allows the computer system to provide a user with an interface from which to select a device to serve as the active hub device, thereby providing improved visual feedback to the user and/or reducing the number of inputs needed to perform an operation.

In some embodiments, the computer system (e.g., 600) is in communication with one or more input devices (e.g., a camera, a depth sensor, a microphone, a hardware input mechanism, a rotatable input mechanism, a heart monitor, a temperature sensor, and/or a touch-sensitive surface). In some embodiments, while displaying (e.g., as described with respect to FIG. 6C), via the display generation component, an identification of a fifth device (e.g., an system, a smart tv, a head-mounted display, a personal computing device, a smart speaker, a smart home controller, a desktop, a laptop, a smart appliance, and/or a device that stays in the same location) (e.g., within the user interface) different from the first device and the second device (e.g., the third device and/or the fourth device) (and/or while displaying the indication of the first device as the active hub device for the one or more accessory devices and/or the indication of the second device as the active hub device for the one or more accessory devices), the computer system detects, via the one or more input devices, an input (e.g., 605c) (e.g., a selection input and/or a non-selection input) corresponding to the fifth device (and/or the identification of the fifth device). In some embodiments, the input corresponding to the fifth device includes a tap input directed to a user-interface element indicating whether the fifth device is selected as a preferred option to be the active hub device for the one or more accessory devices. In some embodiments, the same location includes a same vicinity, a same area, a same room, and/or a same building. In some embodiments, in response to detecting the input corresponding to the fifth device and in accordance with a determination that a state of the fifth device is in a third state (e.g., software updates turned off, software version not up to date, and/or another device setting selected), the computer system displays (e.g., as described with respect to FIG. 6D), via the display generation component, a first notification (e.g., 652) (e.g., an indicator graphic, a text, and/or an icon) (e.g., within the user interface) corresponding to (e.g., directed to, at a location of, related to and/or associated with) the third state of the fifth device. In some embodiments, the first notification includes a user interface element for initiating a process to turn on automatic updates for the fifth device. In some embodiments, the computer system detects, via the one or more input devices, one or more inputs, wherein an input (e.g., 605d) (e.g., a selection and/or a non-selection input) of the one or more inputs is detected while displaying the first notification. In some embodiments, the one or more inputs includes a tap input corresponding to a request to update the fifth device. In some embodiments, the one or more inputs includes a tap input corresponding to a request to cause the fifth device to automatically update. In some embodiments, the one or more inputs includes tap inputs corresponding to the user interface element for initiating the process to turn on automatic updates for the fifth device. In some embodiments, in response to detecting the one or more inputs, the computer system displays (e.g., 606 as described with respect to FIG. 6E), via the display generation component, an indication (e.g., an indicator graphic, a text, and/or an icon) (within the user interface) of the fifth device as the active hub device for the one or more accessory devices (e.g., the indication of the fifth device as the active hub device requires the one or more inputs to be detected and is not displayed in response to detecting the input corresponding to the fifth device). In some embodiments, in response to detecting the input corresponding to the fifth device and in accordance with the determination that the state of the fifth device is not in the third state (e.g., software updates turned off, software version not up to date, and/or another device setting selected) (or in another state different from the third state), the computer system displays, via the display generation component, an indication (e.g., an indicator graphic, a text, and/or an icon) (e.g., within the user interface) of the fifth device as the active hub device for the one or more accessory devices. In some embodiments, in response to detecting the input corresponding to the fifth device and in accordance with the determination that the state of the fifth device is in the third state, the computer system forgoes display of, via the display generation component, an indication (e.g., an indicator graphic, a text, and/or an icon) (e.g., within the user interface) of the fifth device as the active hub device for the one or more accessory devices. Displaying a first notification corresponding to a third state of a fifth device and then detecting one or more inputs and, in response, displaying an indication of the fifth device as an active hub device allows the computer system to require a setting for a device to be changed so that the device can be selected as the active hub device, thereby providing improved visual feedback to the user and/or reducing the number of inputs needed to perform an operation.

In some embodiments, the computer system (e.g., 600) is in communication with one or more input devices (e.g., a camera, a depth sensor, a microphone, a hardware input mechanism, a rotatable input mechanism, a heart monitor, a temperature sensor, and/or a touch-sensitive surface). In some embodiments, the computer system Displays (e.g., as described with respect to FIG. 6E), via the display generation component, an identification of a sixth device (e.g., an accessory, a phone, a watch, a tablet, a fitness tracking device, a wearable device, a computer system, a smart tv, a head-mounted display, a personal computing device, a smart speaker, a smart home controller, a desktop, a laptop, a smart appliance, and/or a device that stays in the same location) (e.g., within the user interface) different from the first device and the second device (e.g., the third device, the fourth device, and/or fifth device) (and/or while displaying the indication of the first device as the active hub device for the one or more accessory devices and/or the indication of the second device as the active hub device for the one or more accessory devices), detecting, via the one or more input devices, an input (e.g., 605c) (e.g., a selection input and/or a non-selection input) corresponding to the sixth device (and/or the identification of the sixth device). In some embodiments, the input is tap input corresponding to the sixth device. In some embodiments, the same location includes a same vicinity, a same area, a same room, and/or a same building. In some embodiments, in response to detecting the input corresponding to the sixth device and in accordance with the determination that a state of the sixth device is in a fourth state (e.g., an error state, a fault state, a malfunction state, an inactive state, and/or an off state), the computer system displays (e.g., as described with respect to FIG. 6F), via the display generation component, a second notification (e.g., 656a) (e.g., an indicator graphic, a text, and/or an icon) (e.g., within the user interface) that the sixth device is unable to (e.g., cannot) be the active hub device for the one or more accessory devices. In some embodiments, in response to detecting the input corresponding to the sixth device and in accordance with the determination that a state of the fifth device is not in the fourth state, the computer system displays, via the display generation component, an indication (e.g., an indicator graphic, a text, and/or an icon) (within the user interface) of the sixth device as the active hub device for the one or more accessory devices. Displaying a second notification that a sixth device is unable to be an active hub device in response to detecting an input corresponding to the sixth device allows the computer system to notify a user that a device selected as the active hub cannot perform the functions of the active hub device, thereby providing improved visual feedback to the user and/or performing an operation when a set of conditions has been met without requiring further user input.

In some embodiments, in conjunction with (e.g., in response to, after, and/or while) detecting the state of the first device, in accordance with a determination that a third set of one or more criteria, different from the first set of one or more criteria, is satisfied, wherein the third set of one or more criteria includes the first criterion, the computer system displays (e.g., as described with respect to FIG. 6F), via the display generation component, a third notification (e.g., an indicator graphic, a text, and/or an icon) (e.g., within the user interface) corresponding to (e.g., directed to, at a location of, related to and/or associated with) the first state of the first device. In some embodiments, the third set of one or more criteria includes a criterion that is satisfied when notification (and/or selection and/or display) of the active hub device (and/or the user interface) is configured to occur in the second manner. In some embodiments, in conjunction with detecting the state of the first device, in accordance with a determination that a fourth set of one or more criteria, different from the first set of one or more criteria and the second set of one or more criteria, is satisfied, wherein the fourth set of one or more criteria includes the first criterion, the computer system forgoes display of (e.g., as described with respect to FIG. 6B), via the display generation component, the third notification (e.g., within the user interface) corresponding to the first state of the first device. In some embodiments, the fourth set of one or more criteria includes a criterion that is satisfied when notification (and/or selection and/or display) of the active hub device (and/or the user interface) is configured to occur in the first manner. Selectively displaying a third notification corresponding to a first state of a first device based on a set of one or more criteria being satisfied allows the computer system to intelligently alert a user of errors at the device serving as the active hub device, thereby providing improved visual feedback to the user and/or performing an operation when a set of conditions has been met without requiring further user input.

In some embodiments, while displaying the indication of the first device (and/or the second device) as the active hub device for the one or more accessory devices and in accordance with a determination that a fifth criterion is satisfied, the computer system displays (e.g., as described with respect to FIG. 6C), via the display generation component, a list of hub devices (e.g., potential and/or possible hub devices) (and/or a list of accessory devices and/or a list of devices), wherein the list of hub devices includes an identification of a first device and an identification of a second device different from the identification of the first device (e.g., the second device different from the first device) (e.g., within the user interface), wherein the list of hub devices is ordered by (and/or based on) an order that hub devices will become the active hub device (e.g., when the identification of the first device is ordered above the identification of the second device, the first device will be chosen to be the active hub device before the second device will be chosen to be the active hub device). In some embodiments, the fifth criterion is satisfied when notification (and/or selection and/or display) of the active hub device (and/or the user interface) is configured to occur in the second manner. In some embodiments, the order is automatically determined by the computer system based on the software version of a respective device, device settings of a respective device, device connectivity to a network of a respective device, and/or operation state of a respective device. Displaying a list of devices ordered by an order that the devices will become an active hub device allows the computer system to alert a user of devices that are capable of serving as the active hub device if a current device acting as the active hub device fails, thereby providing improved visual feedback to the user and/or reducing the number of inputs needed to perform an operation.

In some embodiments, the first device belongs (e.g., currently belongs) to (and/or is a part of) a first network (e.g., a home network, a wireless local area network, a personal area network, and/or a local area network). In some embodiments, the computer system (e.g., 600) belongs (e.g., currently belongs) to (and/or is a part of) a second network (e.g., a home network, a wireless local area network, a personal area network, and/or a local area network) different from the first network (e.g., and does not currently belong to the first network). A first device belonging to a first network and the computer system belonging to a second network allows the computer system to communicate with devices in different geographical areas, thereby providing improved feedback to the user and/or performing an operation when a set of conditions has been met without requiring further user input.

In some embodiments, the first device is connected to (and/or belongs to and/or is a part of) a third network (e.g., as described with respect to FIGS. 6A-6H) (e.g., a home network, a wireless local area network, a personal area network, and/or a local area network). In some embodiments, the computer system (e.g., 600) is connected to (and/or belongs to and/or is a part of) the third network. A first device and the computer system being connected to a third network allows the computer system to communicate with devices on the same network, thereby providing improved visual feedback to the user and/or performing an operation when a set of conditions has been met without requiring further user input.

In some embodiments, the one or more accessory devices includes a plurality of accessory devices. In some embodiments, the plurality of accessory devices are in communication with the first device (e.g., and not the second device) while the first device is the active hub device for the one or more accessory devices (e.g., as described with respect to FIG. 6A-6H). In some embodiments, the plurality of accessory devices are in communication with the second device (e.g., and not the second device) while the second device is the active hub device for the one or more accessory devices. A plurality of accessory devices being in communication with a first device while the first device is an active hub device for the plurality of accessory devices allows the computer system to alert a user of a status of devices connected to the active hub device, thereby providing improved visual feedback to the user and/or performing an operation when a set of conditions has been met without requiring further user input.

In some embodiments, the computer system (e.g., 600) communicates, via the first device, (e.g., and not the second device) with the one or more accessories while the first device is the active hub device for the one or more accessories. In some embodiments, the computer system communicates, via the second device (e.g., and not the first device) while the second device is the active hub device for the one or more accessories. The computer system communicating, via a first device, with one or more accessories while the first device is an active hub device for the one or more accessories allows the computer system to communicate with the one or more accessories while the computer system is in a different geographical area than the one or more accessories, thereby providing improved feedback to the user and/or performing an operation when a set of conditions has been met without requiring further user input.

In some embodiments, in response to the detecting the state of the first device and in accordance with a determination that a second set of or more criteria is satisfied (e.g., that the active hub device for the one or more accessory devices is configured to be selected according to a second mode, different from the first mode, and/or one or more other criterions), wherein the second set of one or more criteria includes a criterion that is satisfied when the state of the first device is the first state (e.g., 636), the computer system forgoes (e.g., as described with respect to FIG. 6B) display of, via the display generation component, the indication of the second device as the active hub device for the one or more accessory devices (e.g., even though the second device is established as the active hub device for the one or more accessory devices in place of the first device) (and/or an identification of the second device) (e.g., within the user interface). In some embodiments, forgoing display of the indication of the first device as the active hub device for the one or more accessory devices occurs in conjunction with (e.g., concurrently, after, and/or before) displaying, via the display generation component, the indication of the second device as the active hub device for the one or more accessory devices. In some embodiments, the second mode is an automatic selection mode that causes a notification and/or an indication (e.g., an indication that the first device is no longer the active hub device for the one or more accessory devices) to be displayed (e.g., via the display generation component) when a current device is no longer able to be the active home hub and there are no other devices able to be the active home hub. In some embodiments, the second mode does not cause a notification and/or an indication (e.g., the indication of the second device as the active hub device for the one or more accessory devices) to be displayed (e.g., via the display generation component) when a current device is no longer able to be the active home hub and another device is able to and/or has become the active home hub. In some embodiments, in response to the detecting the state of the first device and in accordance with the determination that the second set of or more criteria is satisfied, the computer system forgoes display of, via the display generation component, an indication corresponding to the first state, such as an indication that the first device is no longer the active hub device for the one or more accessory devices and/or that another device is now the active hub device for the one or more accessory devices. Forgoing display of an indication of a second device as an active hub device in response to detecting a state of a first device allows the computer system to minimize distractions to user based on a user's preference, thereby providing improved visual feedback to the user and/or performing an operation when a set of conditions has been met without requiring further user input.

In some embodiments, in response to the detecting the state of the first device and in accordance with a determination that a second set of or more criteria is satisfied (e.g., that the active hub device for the one or more accessory devices is configured to be selected according to a second mode, different from the first mode, and/or one or more other criterions), wherein the second set of one or more criteria includes a criterion that is satisfied when the state of the first device is a second state (e.g., 616) (e.g., normal operating mode and/or error-free operation mode) different from the first state, the computer system forgoes display of (e.g., as described with respect to FIG. 6A), via the display generation component, the indication of the second device as the active hub device for the one or more accessory devices (e.g., even though the second device is established as the active hub device for the one or more accessory devices in place of the first device) (and/or an identification of the second device) (e.g., within the user interface). In some embodiments, forgoing display of the indication of the first device as the active hub device for the one or more accessory devices occurs in conjunction with (e.g., concurrently, after, and/or before) displaying, via the display generation component, the indication of the second device as the active hub device for the one or more accessory devices. In some embodiments, the second mode is an automatic selection mode that causes a notification and/or an indication (e.g., an indication that the first device is no longer the active hub device for the one or more accessory devices) to be displayed (e.g., via the display generation component) when a current device is no longer able to be the active home hub and there are no other devices able to be the active home hub. In some embodiments, the second mode does not cause a notification and/or an indication (e.g., the indication of the second device as the active hub device for the one or more accessory devices) to be displayed (e.g., via the display generation component) when a current device is no longer able to be the active home hub and another device is able to and/or has become the active home hub. In some embodiments, in response to the detecting the state of the first device and in accordance with the determination that the second set of or more criteria is satisfied, the computer system forgoes display of, via the display generation component, an indication corresponding to the first state, such as an indication that the first device is no longer the active hub device for the one or more accessory devices and/or that another device is now the active hub device for the one or more accessory devices. Forgoing display of an indication of a second device as an active hub device in response to detecting a state of a first device allows the computer system to minimize distractions to a user, thereby providing improved visual feedback to the user and/or performing an operation when a set of conditions has been met without requiring further user input.

Note that details of the processes described above with respect to process 700 (e.g., FIG. 7) are also applicable in an analogous manner to other processes described herein. For example, process 800 optionally includes one or more of the characteristics of the various processes described above with reference to process 700. For example, the displayed indication of a second device of method 700 can occur in response to the state detected in method 800. For brevity, these details are not repeated herein.

FIG. 8 is a flow diagram illustrating a process (e.g., process 800) for displaying a notification of a state of hub device in accordance with some embodiments. Some operations in process 800 are, optionally, combined, the orders of some operations are, optionally, changed, and some operations are, optionally, omitted.

As described below, process 800 provides an intuitive way for displaying a notification of a state of hub device. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., 600) that is in communication with a display generation component (e.g., a display screen, a projector, and/or a touch-sensitive display) and an input device (e.g., a camera, a depth sensor, a microphone, a hardware input mechanism, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device.

The computer system detects (802) (e.g., as described with respect to FIG. 6A and FIG. 6G) (e.g., via a communication from the first device, via a communication from an accessory device of the one or more accessory devices, via a communication from a server, and/or based on lack of a communication received from the first device and/or an accessory device of the one or more accessory devices) a state (e.g., operation state, power state, connectivity state, and/or communication state) corresponding to (e.g., directed to, at a location of, related to and/or associated with) a hub device (e.g., network device, resident device, smart home hub controller, network switch, repeater, and/or concentrator) for one or more accessory devices (e.g., a watch, a wearable device, a smart speaker, a smart TV, a smart appliance, a light, a head-mounted display (HMD), and/or a personal computing device). In some embodiments, detecting the state includes sending a communication to hub device and not receiving a communication from the hub device within a predetermined period of time. In some embodiments, detecting the state includes receiving a communication from the hub device. In some embodiments, detecting the state includes receiving a communication from an accessory device of the one or more accessory devices.

In response to (804) detecting the state corresponding to the hub device for the one or more accessory devices, in accordance with a determination that a first set of one or more criteria is satisfied, wherein the first set of one or more criteria includes a criterion that is satisfied when the hub device for the one or more accessory devices was manually selected (and/or selected by a user) for a network and that the state corresponding to the hub device for the one or more accessory devices corresponds to a first state (e.g., an error state, a fault state, a malfunction state, an inactive state, and/or an off state), the computer system displays (806) (e.g., as described with respect to FIG. 6G), via the display generation component, a first notification (e.g., 660) (e.g., graphic, text, user-interface element, and/or animation) (e.g., within a user interface). In some embodiments, the first state is a state indicating that the hub device does not have updated software. In some embodiments, the first state is a state indicating that the hub device is turned off. In some embodiments, the first state is a state indicating that the hub device is not operating properly. In some embodiments, the first state is a state indicating that the hub device is not communicating with the computer system and/or an accessory device of the one or more accessory devices. In some embodiments, the first state is a state indicating that the hub device has a low connectivity to a network, such as a home network in which a subset of the one or more accessory devices are also connected. In some embodiments, the first state is a state indicating that the hub device has no connectivity to a network, such as a home network in which a subset of the one or more accessory devices are also connected. In some embodiments, the first state is a state indicating that the hub device is not powered properly. In some embodiments, the first state is a state indicating that a power source of the hub device is not properly powering the hub device. In some embodiments, the first state is a state indicating that the hub device is in a sleep mode and/or standby mode.

In response to (804) detecting the state corresponding to the hub device for the one or more accessory devices, in accordance with a determination that a second set of one or more criteria, different from the first set of one or more criteria, is satisfied, wherein the second set of one or more criteria includes a criterion that is satisfied when the state corresponding to the hub device for the one or more accessory devices corresponds to the first state, the computer system forgoes (808) display of (e.g., as described with respect to FIG. 6B), via the display generation component, the first notification. In some embodiments, in response to detecting the state corresponding to the hub device for the one or more accessory devices and in accordance with a determination that another set of one or more criteria is satisfied, wherein the other set of one or more criteria includes a criterion that is satisfied when the state of the hub device is a second state (e.g., a functioning state, a non-error state, a non-malfunction state, an active state, and/or an on state) different from the first state, the computer system forgoes display of, via the display generation component, the first notification. Displaying a notification in response to detecting a state corresponding to a hub device when the hub device was manually selected for a network allows the computer system to alert a user when an error related to a device serving as the hub device is detected, thereby providing improved visual feedback to the user and/or performing an operation when a set of conditions has been met without requiring further user input. Forgoing display of a notification in response to detecting a state corresponding to a hub device allows the computer system to minimize distractions to a user when an error related to a device serving as the hub device is detected, thereby providing improved visual feedback to the user and/or performing an operation when a set of conditions has been met without requiring further user input.

In some embodiments, the first notification includes an identification (e.g., as described with respect to FIG. 6G) (e.g., an IP address, a MAC address, a serial number, a device name, a device identifier, and/or a corresponding user account) of the hub device for the one or more accessory devices (and/or an icon or other graphical representation corresponding to the hub device for the one or more accessory devices). A notification including an identification of a hub device allows the computer system to identify a device assigned as the hub device, thereby providing improved visual feedback to the user and/or performing an operation when a set of conditions has been met without requiring further user input.

In some embodiments, the first notification includes an identification (e.g., as described with respect to FIG. 6G) (e.g., an IP address, a MAC address, a serial number, a device name, a device identifier, and/or a corresponding user account) of another hub device (e.g., an active hub device (e.g., as described above with respect to process 700), a selected hub device, a current hub device, an operating hub device, a main hub device, a new hub device, and/or a master hub device) for the one or more accessory devices for the network (and/or an icon or other graphical representation corresponding to the hub device for the one or more accessory devices). In some embodiments, the other hub device is different from the hub device. A notification including an identification of another hub device for the network allows the computer system to identify a new device assigned as the hub device, thereby providing improved visual feedback to the user and/or performing an operation when a set of conditions has been met without requiring further user input.

In some embodiments, the first state corresponds (e.g., directed to, at a location of, related to and/or associated with) to the hub device for the one or more accessory devices being non-responsive (e.g., 636) (e.g., due to software crash, connectivity issue, overloaded processor, insufficient memory, low battery, power issue, hardware malfunction, overheating, corrupted system file, outdated software, and/or virus). A state causing a notification to be provided corresponding to a hub device being non-responsive allows the computer system to alert a user when an error is detected to a device selected as the hub device, thereby providing improved visual feedback to the user and/or performing an operation when a set of conditions has been met without requiring further user input.

In some embodiments, the first notification is displayed while the computer system (e.g., 600) is operating in a locked state (e.g., as described with respect to FIG. 6G) (e.g., where only certain applications, functions, and/or computer system resources are available). A notification being displayed while the computer system is operating in a locked state allows the computer system to provide the user with an alert when the computer system is operating in various modes, thereby providing improved visual feedback to the user and/or performing an operation when a set of conditions has been met without requiring further user input.

In some embodiments, while displaying the first notification, the computer system detects, via the input device, an input (e.g., 605g) (e.g., a selection input and/or a non-selection input) corresponding to (e.g., directed to, at a location of, related to and/or associated with) the first notification. In some embodiments, the input is a tap input on the first notification. In some embodiments, in response to detecting the input corresponding to the first notification, the computer system displays (e.g., as described with respect to FIG. 6H), via the display generation component, a first user interface corresponding to (e.g., directed to, at a location of, related to and/or associated with) an application (e.g., a smart home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application). Displaying a user interface corresponding to an application in response to detecting an input corresponding to a notification allows the computer system to provide a user access to an appropriate application to address the notification, thereby providing improved visual feedback to the user and/or reducing the number of inputs needed to perform an operation.

In some embodiments, the first set of one or more criteria includes a second criterion that is satisfied when a new hub device (e.g., an active hub device (e.g., as described above with respect to process 700), a selected hub device, a current hub device, an operating hub device, a main hub device, and/or a master hub device) for the one or more accessory devices was automatically (e.g., as described with respect to FIG. 6B) (e.g., not manually) selected for the network. In some embodiments, the second set of one or more criteria includes a second criterion that is satisfied when the new hub device for the one or more accessory devices was automatically selected for the network. In some embodiments, the new hub device is different from the hub device. In some embodiments, the new hub device is automatically selected by the computer system and/or another computer system different from the computer system. A set of one or more criteria to cause a notification be provided including a criterion that is satisfied when a new hub device was automatically selected for a network allows the computer system to alert a user when an error related to a device selected as the hub device is detected, thereby providing improved visual feedback to the user and/or performing an operation when a set of conditions has been met without requiring further user input. A set of one or more criteria to cause a notification not be displayed including a criterion that is satisfied when a new hub device was automatically selected for the network allows the computer system to minimize distractions to user when an error related to a device selected as the hub device is detected, thereby providing improved visual feedback to the user and/or performing an operation when a set of conditions has been met without requiring further user input.

In some embodiments, the first set of one or more criteria includes a second criterion that is satisfied when a new hub device (e.g., an active hub device (e.g., as described above with respect to process 700), a selected hub device, a current hub device, an operating hub device, a main hub device, and/or a master hub device) for the one or more accessory devices was selected for the network. In some embodiments, the new hub device is automatically selected by the computer system and/or another computer system different from the computer system. In some embodiments, the new hub device is different from the hub device. In some embodiments, the hub device for the one or more accessory devices belongs (e.g., currently belongs) to (and/or is part of) a first network (e.g., a home network, a wireless local area network, a personal area network, and/or a local area network). In some embodiments, the new hub device (e.g., network device, resident device, smart home hub controller, network switch, repeater, and/or concentrator) for the one or more accessory devices belongs (e.g., currently belongs) to (and/or is part of) a second network (e.g., a home network, a wireless local area network, a personal area network, and/or a local area network) different from the first network (e.g., and does not currently belongs). An old hub device belonging to a first network and a new hub device belonging to a second network allows the computer system to communicate with devices in different geographical areas, thereby providing improved visual feedback to the user and/or performing an operation when a set of conditions has been met without requiring further user input.

In some embodiments, the first set of one or more criteria includes a second criterion that is satisfied when a new hub device (e.g., an active hub device (e.g., as described above with respect to process 700), a selected hub device, a current hub device, an operating hub device, a main hub device, and/or a master hub device) for the one or more accessory devices was selected for the network. In some embodiments, the new hub device is automatically selected by the computer system and/or another computer system different from the computer system. In some embodiments, the new hub device is different from the hub device. In some embodiments, the hub device for the one or more accessory devices belongs to (and/or is part of) a third network (e.g., a home network, a wireless local area network, a personal area network, and/or a local area network). In some embodiments, the new hub device for the one or more accessory devices belongs to (and/or is part of) the third network. In some embodiments, the computer system (e.g., 600) belongs to (and/or is part of) the third network. An old hub device, a new hub device, and the computer system belonging to a third network allows the computer system to communicate with devices on the same network, thereby providing improved visual feedback to the user and/or performing an operation when a set of conditions has been met without requiring further user input.

In some embodiments, the first set of one or more criteria includes a second criterion that is satisfied when a new hub device (e.g., an active hub device (e.g., as described above with respect to process 700), a selected hub device, a current hub device, an operating hub device, a main hub device, and/or a master hub device) for the one or more accessory devices was selected for the network. In some embodiments, the new hub device is automatically selected by the computer system and/or another computer system different from the computer system. In some embodiments, the second set of one or more criteria includes a second criterion that is satisfied when the new hub device for the one or more accessory devices was selected for the network. In some embodiments, the new hub device is different from the hub device (e.g., as described with respect to FIGS. 6A-6H). In some embodiments, the hub device for the one or more accessory devices belongs to (and/or is a part of) a fourth network (e.g., a home network, a wireless local area network, a personal area network, and/or a local area network) (e.g., as described with respect to FIGS. 6A-6H). In some embodiments, the second hub device for the one or more accessory devices belongs to (and/or is a part of) the fourth network (e.g., as described with respect FIGS. 6A-6H). An old hub device and a new hub device belong to the same network allows the computer system to communicate with devices on a particular network, thereby providing improved visual feedback to the user and/or performing an operation when a set of conditions has been met without requiring further user input.

In some embodiments, the hub device is in communication with (e.g., as described with respect FIGS. 6A-6H) at least one accessory device of the one or more accessory devices while the hub device is an active hub device (e.g., as described above with respect to process 700) (and/or a current hub device and/or an operating hub device) for the one or more accessory devices. While a hub device is an active hub device, the hub device being in communication with at least one accessory device of the one or more accessory devices allows the computer system to control and/or receive data from the accessory device, thereby providing improved visual feedback to the user and/or performing an operation when a set of conditions has been met without requiring further user input.

In some embodiments, the computer system (e.g., 600) is communication, via the hub device, with at least one accessory device of the one or more of the accessory devices while the hub device is an active hub device (e.g., as described above with respect to process 700) (and/or a current hub device and/or an operating hub device) for the one or more accessory devices. While a hub device is an active hub device, the computer system being in communication, via the hub device, with at least one accessory device of the one or more of the accessory devices allows the computer system to control and/or receive data from the accessory device, thereby providing improved visual feedback to the user and/or performing an operation when a set of conditions has been met without requiring further user input.

In some embodiments, in response to detecting the state corresponding to the hub device for the one or more accessory devices and in accordance with a determination that a third set of one or more criteria, different from the first set of one or more criteria and the second set of one or more criteria is satisfied, wherein the third set of one or more criteria includes a criterion that is satisfied when the state corresponding to the hub device for the one or more accessory devices corresponds to the first state (e.g., 636) and when the network does not include another hub device different from the hub device, the computer system displays, via the display generation component, a second notification (e.g., different from the first notification). Displaying a notification in response to detecting a state corresponding to a hub device when a network does not include another hub device allows the computer system to alert a user when no hub device is available, thereby providing improved visual feedback to the user and/or performing an operation when a set of conditions has been met without requiring further user input.

In some embodiments, the hub device is a first hub device. In some embodiments, the first notification includes, in accordance with a determination that a second hub device (e.g., an active hub device (e.g., as described above with respect to process 700), a selected hub device, a current hub device, an operating hub device, a main hub device, and/or a master hub device) for the one or more accessory devices is selected for the network, an identification (e.g., as described with respect to FIG. 6G) (e.g., an IP address, a MAC address, a serial number, a device name, a device identifier, and/or a corresponding user account) of the second hub device. In some embodiments, the second hub device is different from the first hub device. In some embodiments, the first notification includes, in accordance with a determination that a third hub device (e.g., an active hub device (e.g., as described above with respect to process 700), a selected hub device, a current hub device, an operating hub device, a main hub device, and/or a master hub device) for the one or more accessory devices is selected for the network, an identification (e.g., an IP address, a MAC address, a serial number, a device name, a device identifier, and/or a corresponding user account) of the third hub device. In some embodiments, the third hub device is different from the first hub device and the second hub device. A notification including an identification of a hub device when the hub device is selected for a network allows the computer system to alert a user of a new device serving as the hub device, thereby providing improved visual feedback to the user and/or performing an operation when a set of conditions has been met without requiring further user input.

Note that details of the processes described above with respect to process 800 (e.g., FIG. 8) are also applicable in an analogous manner to the processes described herein. For example, process 700 optionally includes one or more of the characteristics of the various processes described herein with reference to process 800. For example, the first notification of method 800 can occur in response to the detected state of the first device of method 700. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve managing home hubs. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for managing home hubs. Accordingly, use of such personal information data enables users to have a computer system perform operations for managing home hubs. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a computer system that is in communication with a display generation component:
while displaying, via the display generation component, an indication of a first device as an active hub device for one or more accessory devices, detecting a state of the first device; and
in response to detecting the state of the first device and in accordance with a determination that a first set of one or more criteria is satisfied, wherein the first set of one or more criteria includes a first criterion that is satisfied when the state of the first device is a first state:
ceasing display of, via the display generation component, the indication of the first device as the active hub device for the one or more accessory devices; and
displaying, via the display generation component, an indication of a second device as the active hub device for the one or more accessory devices, wherein the indication of the first device as the active hub device for the one or more accessory devices is different from the indication of the second device as the active hub device for the one or more accessory devices, and wherein the second device is different from the first device.

2. The method of claim 1, wherein the indication of the first device as the active hub device for the one or more accessory devices includes an identification of the first device.

3. The method of claim 1, wherein the indication of the second device as the active hub device for the one or more accessory devices includes an identification of the second device.

4. The method of claim 1, further comprising:
in response to detecting the state of the first device and in accordance with the determination that the first set of or more criteria is satisfied, forgoing display of, via the display generation component, an identification of the first device.

5. The method of claim 1, wherein the first set of one or more criteria includes a second criterion that is satisfied when notification of the active hub device is configured to occur in a first manner, the method further comprising:
before detecting the state of the first device and in accordance with a determination that the second criterion is satisfied, forgoing display of, via the display generation component, an identification of the second device.

6. The method of claim 1, further comprising:
before detecting the state of the first device and in accordance with a determination that a third criterion, different from the first criterion, is satisfied, wherein the third criterion is satisfied when notification of the active hub device is configured to occur in a second manner, displaying, via the display generation component, an identification of the second device.

7. The method of claim 1, further comprising:
before detecting the state of the first device and in accordance with a determination that a third criterion, different from the first criterion, is satisfied, wherein the third criterion is satisfied when notification of the active hub device is configured to occur in a second manner, displaying, via the display generation component, an identification of the first device that is separate from the indication of the first device as the active hub device for the one or more accessory devices.

8. The method of claim 1, further comprising:
in response to detecting the state of the first device and in accordance with a determination that a second set of one or more criteria, different from the first set of one or more criteria, is satisfied, wherein the second set of one or more criteria includes a criterion that is satisfied when the state of the first device is the first state:
ceasing display of, via the display generation component, the indication of the first device as the active hub device for the one or more accessory devices; and
displaying, via the display generation component, an indication of a third device as the active hub device for the one or more accessory devices, wherein the indication of the third device as the active hub device for the one or more accessory devices is different from the indication of the first device as the active hub device for the one or more accessory devices and the indication of the second device as the active hub device for the one or more accessory devices, and wherein the third device is different from the first device and the second device.

9. The method of claim 1, wherein the computer system is in communication with one or more input devices, the method further comprising:
while displaying, via the display generation component, an identification of a fourth device different from the first device and the second device, detecting, via the one or more input devices, an input corresponding to the fourth device; and
in response to detecting the input corresponding to the fourth device, displaying, via the display generation component, an indication of the fourth device as the active hub device for the one or more accessory devices.

10. The method of claim 1, wherein the computer system is in communication with one or more input devices, the method further comprising:
while displaying, via the display generation component, an identification of a fifth device different from the first device and the second device, detecting, via the one or more input devices, an input corresponding to the fifth device;
in response to detecting the input corresponding to the fifth device and in accordance with a determination that a state of the fifth device is in a third state, displaying, via the display generation component, a first notification corresponding to the third state of the fifth device;
detecting, via the one or more input devices, one or more inputs, wherein an input of the one or more inputs is detected while displaying the first notification; and
in response to detecting the one or more inputs, displaying, via the display generation component, an indication of the fifth device as the active hub device for the one or more accessory devices.

11. The method of claim 1, wherein the computer system is in communication with one or more input devices, the method further comprising:
displaying, via the display generation component, an identification of a sixth device different from the first device and the second device, detecting, via the one or more input devices, an input corresponding to the sixth device; and
in response to detecting the input corresponding to the sixth device and in accordance with the determination that a state of the sixth device is in a fourth state, displaying, via the display generation component, a second notification that the sixth device is unable to be the active hub device for the one or more accessory devices.

12. The method of claim 1, further comprising:
in conjunction with detecting the state of the first device:
in accordance with a determination that a third set of one or more criteria, different from the first set of one or more criteria, is satisfied, wherein the third set of one or more criteria includes the first criterion, displaying, via the display generation component, a third notification corresponding to the first state of the first device; and
in accordance with a determination that a fourth set of one or more criteria, different from the first set of one or more criteria and the second set of one or more criteria, is satisfied, wherein the fourth set of one or more criteria includes the first criterion, forgoing display of, via the display generation component, the third notification corresponding to the first state of the first device.

13. The method of claim 1, further comprising:
while displaying the indication of the first device as the active hub device for the one or more accessory devices and in accordance with a determination that a fifth criterion is satisfied, displaying, via the display generation component, a list of hub devices, wherein the list of hub devices includes an identification of a first device and an identification of a second device different from the identification of the first device, wherein the list of hub devices is ordered by an order that hub devices will become the active hub device.

14. The method of claim 1, wherein the first device belongs to a first network, and wherein the computer system belongs to a second network different from the first network.

15. The method of claim 1, wherein the first device is connected to a third network, and wherein the computer system is connected to the third network.

16. The method of claim 1, wherein the one or more accessory devices includes a plurality of accessory devices, and wherein the plurality of accessory devices are in communication with the first device while the first device is the active hub device for the one or more accessory devices.

17. The method of claim 1, wherein the computer system communicates, via the first device, with the one or more accessories while the first device is the active hub device for the one or more accessories.

18. The method of claim 1, further comprising:
in response to the detecting the state of the first device and in accordance with a determination that a second set of or more criteria is satisfied, wherein the second set of one or more criteria includes a criterion that is satisfied when the state of the first device is the first state, forgoing display of, via the display generation component, the indication of the second device as the active hub device for the one or more accessory devices.

19. The method of claim 1, further comprising:
in response to the detecting the state of the first device and in accordance with a determination that a second set of or more criteria is satisfied, wherein the second set of one or more criteria includes a criterion that is satisfied when the state of the first device is a second state different from the first state, forgoing display of, via the display generation component, the indication of the second device as the active hub device for the one or more accessory devices.

20. A non-transitory computer-readable storage medium storing one or more programs configured to be executed by one or more processors of a computer system that is in communication with a display generation component, the one or more programs including instructions for:
while displaying, via the display generation component, an indication of a first device as an active hub device for one or more accessory devices, detecting a state of the first device; and
in response to detecting the state of the first device and in accordance with a determination that a first set of one or more criteria is satisfied, wherein the first set of one or more criteria includes a first criterion that is satisfied when the state of the first device is a first state:
ceasing display of, via the display generation component, the indication of the first device as the active hub device for the one or more accessory devices; and
displaying, via the display generation component, an indication of a second device as the active hub device for the one or more accessory devices, wherein the indication of the first device as the active hub device for the one or more accessory devices is different from the indication of the second device as the active hub device for the one or more accessory devices, and wherein the second device is different from the first device.

21. A computer system configured to communicate with a display generation component, comprising:
one or more processors; and
memory storing one or more programs configured to be executed by the one or more processors, the one or more programs including instructions for:
while displaying, via the display generation component, an indication of a first device as an active hub device for one or more accessory devices, detecting a state of the first device; and
in response to detecting the state of the first device and in accordance with a determination that a first set of one or more criteria is satisfied, wherein the first set of one or more criteria includes a first criterion that is satisfied when the state of the first device is a first state:
ceasing display of, via the display generation component, the indication of the first device as the active hub device for the one or more accessory devices; and
displaying, via the display generation component, an indication of a second device as the active hub device for the one or more accessory devices, wherein the indication of the first device as the active hub device for the one or more accessory devices is different from the indication of the second device as the active hub device for the one or more accessory devices, and wherein the second device is different from the first device.
